(19) United States
(12) Patent Application Publication
(10) Pub. No.: US 2021/0134252 A1
(43) Pub. Date: May 6, 2021

(54) IMAGE PROCESSING APPARATUS AND DISPLAY APPARATUS

(71) Applicant: SHARP KABUSHIKI KAISHA, Sakai City, Osaka (JP)

(72) Inventor: TATSUNORI NAKAMURA, Sakai City, Osaka (JP)

(21) Appl. No.: 16/769,848

(22) PCT Filed: Nov. 30, 2018
(86) PCT No.: PCT/JP2018/044188

§ 371 Date: Jun. 4, 2020

(30) Foreign Application Priority Data
Dec. 6, 2017 (JP) 2017-234292

(51) Int. Cl. G09G 5/397; G06T 5/50; G06T 3/40

(52) U.S. Cl. CPC G09G 5/397; G09G 2360/122; G06T 3/4038; G06T 5/50

(57) ABSTRACT

A configuration of an image processing apparatus is simplified. In a display apparatus, a first sub input image and a second sub input image are input to a first back-end processor, and a first residual input image and a second residual input image are input to a second back-end processor. A first entire input image is constituted by combining the first sub input image and the first input image. In a case where the display apparatus processes the first entire input image, the first back-end processor processes the first sub input image, and the second back-end processor processes the first residual input image.

### TECHNICAL FIELD

The present disclosure relates to an image processing apparatus including a first image processor and a second image processor. The present disclosure contains subject matter related to that disclosed in Japanese Priority Patent Application JP 2017-234292 filed in the Japan Patent Office on Dec. 6, 2017, the entire contents of which are hereby incorporated by reference.

### BACKGROUND ART

PTL 1 discloses as image processing apparatus for efficiently processing a plurality of pieces of image data. As an example, the image processing apparatus of PTL 1 includes two image processors.

### CITATION LIST

### Patent Literature

PTL 1: Japanese Unexamined Patent Application Publication No. 2016-184775

### SUMMARY OF INVENTION

### Technical Problem

An object of an aspect of the present disclosure is to simplify the configuration of the image processing apparatus as compared with the configuration in the related art.

### Solution to Problem

In order to solve the problem, according to an aspect of the present disclosure, there is provided an image processing apparatus including: a first image processor; and a second image processor, in which a first entire input image is constituted by combining a first sub input image and a first residual input image, in which a second entire input image is constituted by combining a second sub input image and a second residual input image, in which the first sub input image and the second sub input image are input to the first image processor, in which the first residual input image and the second residual input image are input to the second image processor, in which the image processing apparatus processes one of the first entire input image and the second entire input image, in which, in a case where the image processing apparatus processes the first entire input image, the first image processor processes the first sub input image, and the second image processor processes the first residual input image, and in which, in a case where the image processing apparatus processes the second entire input image, the first image processor processes the second sub input image, and the second image processor processes the second residual input image.

In order to solve the problem, according to another aspect of the present disclosure, there is provided an image processing apparatus including: a first image processor; and a second image processor, in which a first entire input image is constituted by four first-unit input images, in which a second entire input image is constituted by four second-unit input images, in which the image processing apparatus processes one of the first entire input image and the second entire input image, in which the first entire input image and the second entire input image are input to the first image processor and the second image processor according to any one of following (input mode 1) and (input mode 2), (input mode 1): the four first-unit input images are input to the first image processor, and the four second-unit input images are input to the second image processor, (input mode 2): three of the first-unit input images and one of the second-unit input images are input to the first image processor, and one of the first-unit input images and three of the second-unit input images, which are not input to the first image processor, are input to the second image processor; in which, in a case where the image processing apparatus processes the first entire input image, the first image processor (i) processes one or more predetermined first-unit input images among three or more first-unit input images which are input to the first image processor, and (ii) supplies remaining first-unit input images excluding the one or more predetermined first-unit input images, to the second image processor, and the second image processor processes at least one of (i) the one of the first-unit input images which is not input to the first image processor and (ii) the remaining first-unit input images supplied from the first image processor, and in which, in a case where the image processing apparatus processes the second entire input image, the second image processor (i) processes one or more predetermined second-unit input images among three or more second-unit input images which are input to the second image processor, and (ii) supplies remaining second-unit input images excluding the one or more predetermined second-unit input images, to the first image processor, and the first image processor processes at least one of (i) the one of the second-unit input images which is not input to the second image processor and (ii) the remaining second-unit input images supplied from the second image processor.

### Advantageous Effects of Invention

According to the image processing apparatus of an aspect of the present invention, a configuration of the image processing apparatus can be simplified as compared with toe configuration in the related art.

### BRIEF DESCRIPTION OF DRAWINGS

FIG. 1 is a functional block diagram Illustrating a configuration of a main part of a display apparatus according to Embodiment 1.

FIG. 2 is a functional block diagram Illustrating a configuration of a main part of a display apparatus as a comparative example.

FIGS. 3(a) to 3(c) are diagrams for explaining images which are input to a back-end processor of FIG. 1.

FIGS. 4(a) to 4(c) are diagrams for explaining an example of images processed by the back-end processor of FIG. 1.

FIGS. 5(a) and 5(b) are functional block diagrams more specifically illustrating configurations of a first back-end processor and a second back-end processor of FIG. 1.

FIGS. 6(a) to 6(c) are diagrams for explaining another example of images processed by the back-end processor of FIG. 1.

FIG. 7 is a functional block diagram illustrating a configuration of a main part of a display apparatus according to Embodiment 2.

FIG. 8 is a functional block diagram illustrating a configuration of a main part of a display apparatus according to Embodiment 3.

FIGS. 9(a) to 9(d) are diagrams for explaining an example of an operation of a back-end processor of FIG. 8.

FIG. 10 is a functional block diagram illustrating a configuration of a main part of a display apparatus according to Embodiment 4.

FIGS. 11(a) to 11(c) are diagrams for explaining another effect of the display apparatus of FIG. 10.

FIG. 12 is a functional block diagram illustrating a configuration of a main part of a display apparatus according to Embodiment 5.

FIG. 13 is a functional block diagram illustrating a configuration of a main part of a display apparatus according to Embodiment 6.

FIG. 14 is a functional block diagram illustrating a configuration of a main part of a display apparatus according to Embodiment 7.

FIGS. 15(a) to 15(d) are diagrams for explaining images which are input to a back-end processor of FIG. 14.

FIG. 16 is a functional block diagram illustrating a configuration of a main part of a display apparatus according to a modification example of Embodiment 7.

FIGS. 17(a) and 17(b) are diagrams for explaining images which are input to a back-end processor of FIG. 16.

FIG. 18 is a functional block diagram illustrating a configuration of a main part of a display apparatus according to Embodiment 8.

FIGS. 19(a) and 19(b) are diagrams for explaining images which are input to a back-end processor of FIG. 18.

### DESCRIPTION OF EMBODIMENTS

### Embodiment 1

Hereinafter, a display apparatus 1 (an image processing apparatus) according to Embodiment 1 will be described. For convenience of descriptions, in each of the following embodiments, members having the same functions as the members described in Embodiment 1 will be denoted by the same reference numerals, and a description thereof will not be repeated.

(Display Apparatus 1)

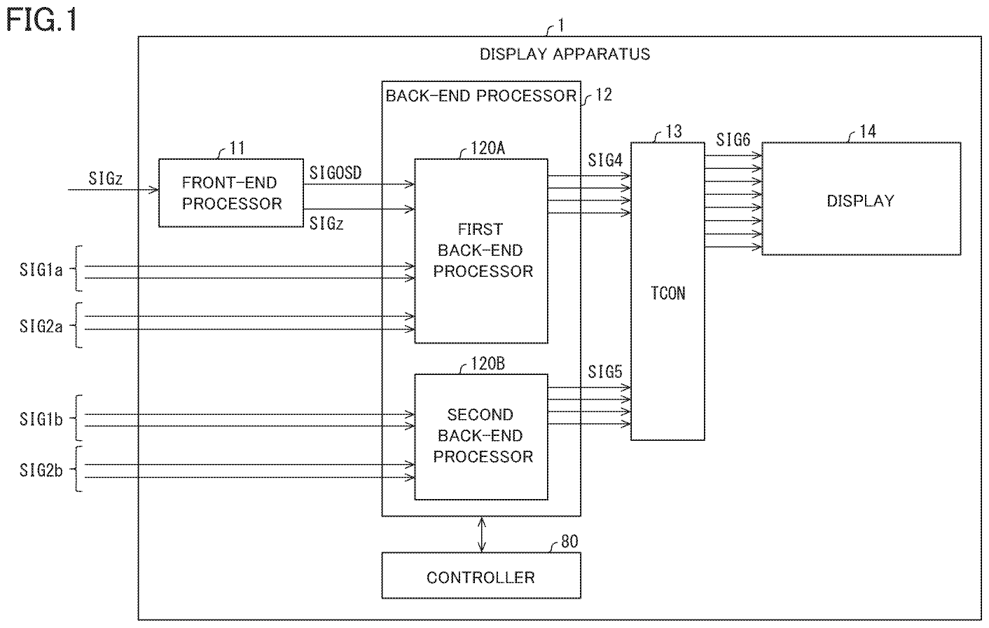

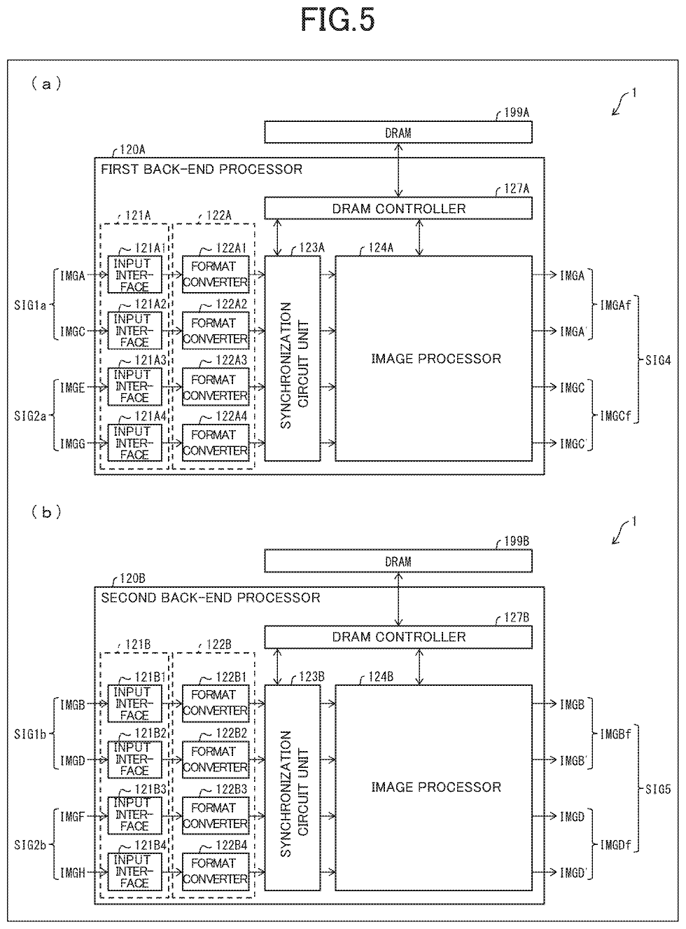

FIG. 1 is a functional block diagram illustrating a configuration of a main part of the display apparatus 1. The display apparatus 1 includes a front-end processor 11, a back-end processor 12, a timing controller (TCON) 13, a display 14, and a controller 80. The back-end processor 12 includes a first back-end processor 120A (first image processor) and a second back-end processor 120B (second image processor). In addition, the display apparatus 1 includes dynamic random access memories (DRAMs) 199A and 199k (refer to FIGS. 5(a) and 5(b) to be described later).

“image” may be referred to as “moving picture image”. In this specification, “image signal” is also simply referred to as “image”. In addition, “image processing apparatus” generically means the units of the display apparatus 1 excluding the display 14. The back-end processor 12 is a main part of the image processing apparatus.

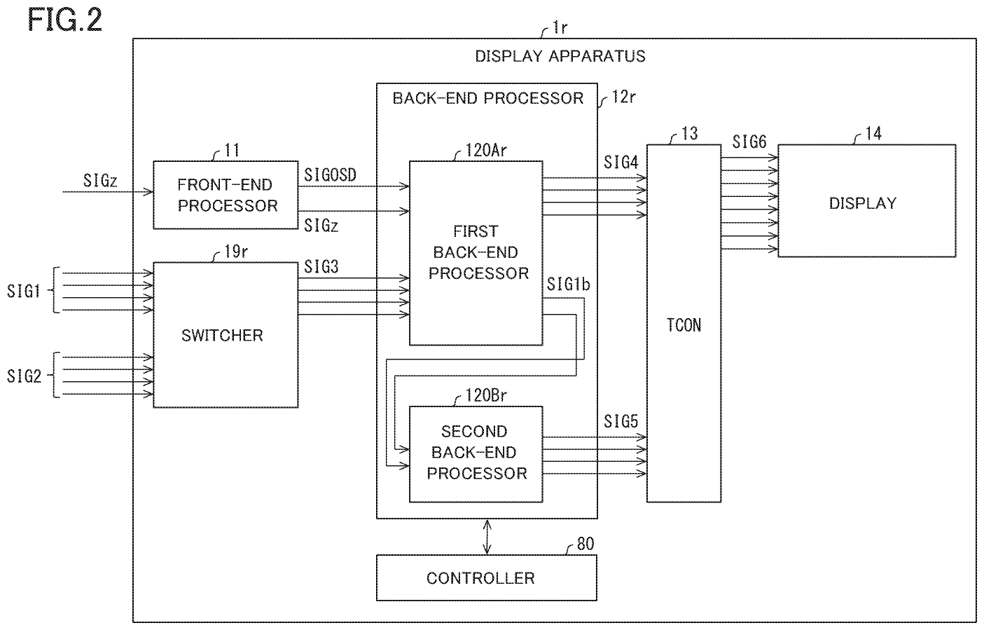

FIG. 2 is a functional block diagram illustrating a configuration of a main part of a display apparatus 1r as a comparative example of the display apparatus 1. As described below, the display apparatus 1r is different from the display apparatus 1 at least in that a switcher 19r is included. In the display apparatus 1, unlike the display apparatus 1r, the switcher 19r may be omitted.

Embodiment 1 exemplifies a case where one 8K4K image (an image having a resolution of 8K4K) is displayed on the display 14. “8K4K” means a resolution of “7680 horizontal pixels×4320 vertical pixels”. “8K4K” is also simply referred to as “8K”.

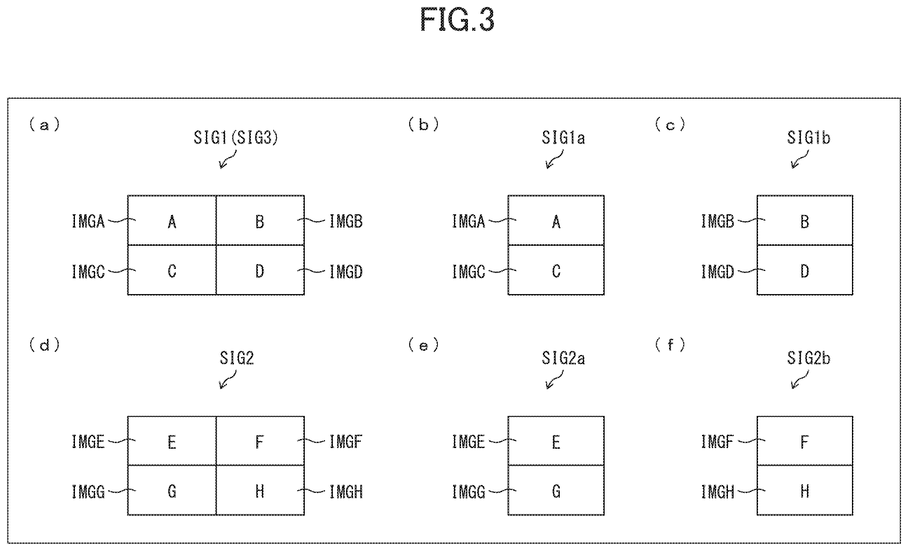

On the other hand, “4K2K” means a resolution of “3840 horizontal pixels×2160 vertical pixels”. One 8K4K image can be represented as an image including four (two in a horizontal direction and two in a vertical direction) 4K2K images (images having a resolution of 4K2K) (for example, refer to FIG. 3(a) to be described later). That is, one 8K4K image can be represented by combining four 4K2K images. “4K2K” is also simply referred to as “4K.”.

Further, “4K4K” means a resolution of “3840 horizontal pixels×3840 vertical pixels”. One 4K4K image (an image having a resolution of 4K4K) can be constituted by arranging two 4K2K images in the vertical direction. (for example, refer to FIG. 3(b)). In addition, one 8K4K image can be constituted by arranging two 4K4K images in the horizontal direction (for example, refer to FIG. 3(a)).

In Embodiment 1, an image displayed by the display 14 is referred to as a display image. In Embodiment 1, it is assumed that the display image is an 8K image with a frame rate of 120 Hz (120 fps (frames per second)). In the example of FIG. 1, SIG6 (to be described later) is a display image. In FIG. 1, for convenience of description, a data area of a 4K image with a frame rate of 60 Hz is indicated by one arrow. Thus, SIG6 is indicated by eight arrows.

In Embodiment 1, the display 14 is an 8K display (a display having a resolution of 8K) that can display an 8K image. A display surface (a display area, a display screen) of the display 14 is divided into four (two in the horizontal direction and two in the vertical direction) partial display areas. Each of the four partial display areas has a resolution of 4K. Each of the four partial display areas can display a 4K image (for example, IMGAf to IMGDf to be described later) with a frame rate of 120 Hz.

In FIG. 1, a 4K image with a frame rate of 120 Hz indicated by two arrows. The display image (indicated by eight arrows) is represented by combining four 4K images (indicated by two arrows) with a frame rate of 120 Hz.

The controller 80 integrally controls each unit of the display apparatus 1. The front-end processor 11 acquires a 4K image SIGz from outside. Further, the front-end processor 11 generates an on screen display (OSD) image SIGOSD. The OSD image may be, for example, an image indicating an electronic program guide.

The front-end processor 11 supplies SIGz and SIGOSD to the first back-end processor 120A. The OSD image may be superimposed on SIG4 (to be described later). Here, Embodiment 1 exemplifies a case where the OSD image is not superimposed.

The back-end processor 12 processes a plurality of input images and outputs a plurality of processed images to the TCON 13. The processing of the back-end processor 12 includes frame rate conversion, enlargement processing, local dimming processing, and the like. The back-end processor 12 according to Embodiment 1 converts one 8K image with a frame rate of 60 Hz into one 8K image with a frame rate of 120 Hz. That is, the back-end processor 12 increases the frame rate of one 8K image by two times.

One 8K image which is input to the back-end processor 12 is represented by a combination of four 4K images. Thus, (i) four 4K images constituting one 8K image and (ii) four 4K images constituting another one OK image are input to the back-end processor 12. Hereinafter, the two 8K images which are input to the back-end processor 12 will be respectively referred to as SIG1 and SIG2. The back-end processor 12 increases the frame rate of each of the four 4K images constituting one 8K image (one of SIG1 and SIG2) by two times.

In Embodiment 1, the back-end processor 12 acquires SIG1 and SIG2 from outside. Ia addition, the back-end processor 12 processes one of SIG1 and SIG2. Embodiment 1 exemplifies a case where the back-end processor 12 processes SIG1. Hereinafter, the 8K image represented by SIG1 is referred to as a first entire input image. Further, the 8K image represented by SIG2 is referred to as a second entire input image.

Each of the first back-end processor 120A and the second back-end processor 120B has a function of processing two 4K images with a frame rate of 60 Hz. Thus, the back-end processor 12 can process one 8K image with a frame rate of 60 Hz by the first back-end processor 120A and the second back-end processor 120B included in the back-end processor 12. That is, the back-end processor 12 can process one of SIG1 and SIG2.

FIGS. 3(a) to 3(f) are diagrams for explaining images which are input to the back-end processor 12. As illustrated in FIG. 3(a) , SIG1 is represented by a combination of IMGA to IMGD (four 4K images with a frame rate of 60 Hz). In FIGS. 3(a) to 3(f), images represented by IMGA to IMGD are indicated by characters “A” to “D” for simplicity. SIG3 illustrated in FIG. 3(a) will be described later. Each of IMGA to IMGD is also referred to as a first partial input image (first-unit input image). The first partial input image is a basic unit constituting the first entire input image.

As illustrated in FIG. 3(b), an image in which IMGA and IMGC (two 4K images) are arranged (combined) in the vertical direction is referred to as SIG1a. SIG1a is a portion (half) of SIG1. More specifically, SIG1a is the left half of the first entire input image. Hereinafter, SIG1a is referred to as a first sub input image. The first sub input image is a 4K4K image. Similarly, SIG1b (first residual input image) to be described below is also a 4K4K image.

On the other hand, as illustrated in FIG. 3(c), an image in which. INGE and IMGD (two 4K images) are arranged (combined) in the vertical direction is referred to as SIG1b. SIG1b is a portion obtained by excluding SIG1a from SIG1 (a residual portion, a remaining half). More specifically, SIG1b is the right half of the first entire input image. Hereinafter, SIG1b is referred to as a first residual input image. The first residual input image is an image obtained by excluding the first sub input image from the first entire input image. As described above, SIG1 canal be represented as a combination of SIG1a and SIG1b (also refer to FIG. 3(a)

Further, as illustrated in FIG. 3(d), SIG2 is represented by a combination of IMGE to IMGH (four 4K images with a frame rate of 60 Hz). In FIG. 2, images represented by IMGE to IMGH are indicated by characters “E” to “H” for simplicity. Each of IMGE to IMGH is also referred to as a second partial input image (second-unit input image). The second partial input image is a basic unit constituting the second entire input image.

As illustrated in FIG. 3(e), an image in which IMGE and IMGG (two 4K images) are arranged (combined) in the vertical direction is referred to as SIG2a. SIG2a is a portion (half) of SIG2. More specifically, SIG2a is the left half of the second entire input image. Hereinafter, SIG2a is referred to as a second sub input image. The second sub input image is a 4K4K image. Similarly, SIG2b (second residual input image) to be described below is also a 4K4K image.

On the other hand, as illustrated in FIG. 3(f), an image in which IMGF and IMGH (two 4K images) are arranged (combined) in the vertical direction is referred to as SIG2b. SIG2b is a portion obtained by excluding SIG2a from SIG2 (a residual portion). More specifically, SIG2b is the right half of the second entire input image. Hereinafter, SIG2b is referred to as a second residual input image. The second residual input image is an image obtained by excluding the second sub input image from the second entire input image. As described above, SIG2 can be represented as a combination of SIG2a and SIG2b (also refer to FIG. 3(d)).

As illustrated in FIG. 1, SIG1a (first sub input image) and SIG2a (second sub input image) are input to the first back-end processor 120A In addition, the first back-end processor 120A processes one of SIG1a and SIG2a Hereinafter, a case where the first back-end processor 120A processes SIG1a is mainly described. The first back-end processor 120A processes SIG1a and outputs SIG4 as a processed image.

On the other hand, SIG1b (first residual input image) and SIG2b (second residual input image) are input to the second back-end processor 120B. In addition, the second back-end processor 120B processes one of SIG1a and SIG2b. Hereinafter, a case where the second back-end processor 120B processes SIG1b is mainly described. The second back-end processor 120B processes SIG2a and outputs SIG5 as a processed image.

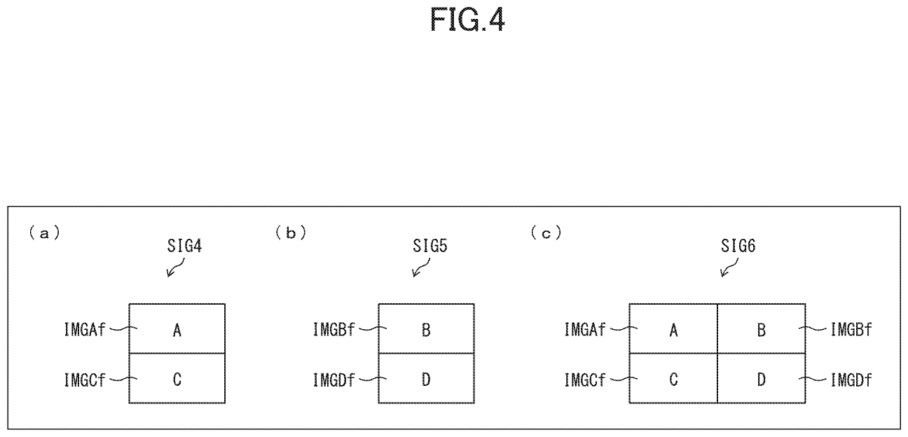

FIGS. 4(a) to 4(c) are diagrams for explaining an example of images processed by the back-end processor 12. FIG. 4(a) illustrates an example of SIG4. SIG4 is an image obtained by converting the frame rate (60 Hz) of SIG1a to 120 Hz. Thus, in FIG. 1, SIG4 is indicated by four arrows. The first back-end processor 120A supplies SIG4 to the TCON 13.

As illustrated in FIG. 4(a), SIG4 is represented by a combination of IMGAf and IMGCf. IMGA±is an image obtained by converting the frame rate (60 Hz) of IMGA to 120 Hz. In addition, IMGCf is an image obtained by converting the frame rate (60 Hz) of IMGC to 120 Hz.

FIG. 4(b) illustrates an example of SIG5. SIG5 is an image obtained by converting the frame rate (60 Hz) of SIG1b to 120 Hz. Thus, in FIG. 1, SIG5 is also indicated by four arrows, similar to SIG4. The second back-end processor 120B supplies SIG5 to the TCON 13.

As illustrated in FIG. 4(b), SIG5 is represented by a combination of IMGEf and IMGDf. IMGEf is an image obtained by converting the frame rate (60 Hz) of IMG E to 120 Hz. In addition, IMGDf image obtained by converting the frame rate (60 Hz) of IMGD to 120 Hz.

The TCON 13 acquires (i) SIG4 from the first back-end processor 120A and (ii) SIG5 from the second back-end processor 120A. The TCON 13 converts formats of S1G4 and SIG5 so as to make SIG4 and SIG5 suitable for display on the display 14. In addition, the TCON 13 rearranges SIG4 and SIG5 so as to make S1G4 and SIG5 suitable for display on the display 14. The TCON 13 sup plies a signal obtained by combining SIG4 and SIG5 to the display 14, as SIG6.

FIG. 4(c) illustrates an example of SIG6. As illustrated in FIG. 4(c), SIG6 is represented as a combination of IMGAf to IMGDf (four 4K images with a frame rate of 120 Hz). That is, SIG6 is represented as a combination of SIG5 and SIG6. Thus, SIG6 (display image) may be referred to as an entire output image. In Embodiment 1, the entire output image is an image obtained by converting the frame rate (60 Hz) of the first entire input image (8K image) to 120 Hz.

(First Back-End Processor 120A and Second Back-End Processor 120B)

FIGS. 5(a) and 5(b) are functional block diagrams more specifically illustrating configurations of the first back-end processor 120A and the second back-end processor 120B. FIG. 5(a) illustrates a configuration of the first back-end processor 120A. In addition, FIG. 5(b) illustrates a configuration of the second back-end processor 120B. Since the configurations of the first back-end processor 120A and the second back-end processor 120B are the same, in the following, the first back-end processor 120A will be mainly described with reference to FIG. 5(a).

The first back-end processor 120A includes an input interface 121A, a format converter 122A, a synchronization circuit unit 123A, an image processor 124A, and a DRAM controller 127A. The input interface 121A generically indicates four input interfaces 121A1 to 121A4. In addition, the format converter 122A generically indicates four format converters 122A1 to 122A4.

The DRAM 199A temporarily stores the image being processed by the first back-end processor 120A. The DRAM 199A functions as a frame memory for storing each frame of the image. As the DRAM 199A, a known double data rate (DDR) memory is used. The DRAM controller 127A controls an operation of the DRAM 199A (in particular, reading and writing of each frame of the image).

The input interface 121A acquires SIG1a and SIG2a. Specifically, the input interface 121A1 acquires IMGA, and the input interface 121A2 acquires IMGC. In this way, the input interface 121A1 and the input interface 121A2 acquire SIG1a.

On the other hand, the input interface 121A3 acquires IMGE, and the input interface 12124 acquires IMGG. In this way, the input interface 121A3 and the input interface 121A4 acquire SIG2a.

The format converter 122A acquires SIG1a and SIG2a from the input interface 121A. The format converter 122A converts formats of SIG1a and SIG2a so as to make SIG1a and SIG2a suitable for synchronization processing and image processing to be described below. Specifically, the format converters 122A1 to 122A4 respectively convert formats of IMGA, IMGC, IME, and IMGG.

The format converter 122A supplies one of SIG1a and SIG2a with a converted format, to the synchronization circuit unit 123A. In the example of FIG. 5(a), the format converter 122A supplies SIG1a (IMGA and IMGC) with a converted format, to the synchronization circuit unit 123A. The format converter 122A may include a selection unit (not illustrated) for selecting an image to be supplied to the synchronization circuit unit 123A (that is, an image to be processed by the second back-end processor 120B).

The synchronization circuit unit 123A acquires SIG1a from the format converter 122A. The synchronization circuit unit 123A performs synchronization processing on each of IMGA and IMGC. The “synchronization processing” refers to processing of adjusting timings and data arrangement of each of IMGA and IMGC for image processing in the subsequent image processor 124A.

The synchronization circuit unit 123A accesses the DRAM 199A (for example, DDR memory) via the DRAM controller 127A. The synchronization circuit unit 123A performs synchronization processing by using the DRAM 199A as a frame memory.

The synchronization circuit unit 123A may further perform scale (resolution) conversion on each of IMGA and IMGC. Further, the synchronization circuit unit 123A may further perform processing of superimposing a predetermined image on each of IMGA and IMGC.

The image processor 124A simultaneously (parallelly) performs image processing on IMGA and IMGC after the synchronization processing is performed. The image processing in the image processor 124A is known processing for improving an image quality of IMGA and IMGC. For example, the image processor 124A performs known filtering processing on IMGA and IMGC.

Further, the image processor 124A can also perform frame rate conversion (for example, up-conversion) as image processing. The image processor 124A converts the frame rates of IMGA and IMGC after filtering processing is performed. As an example, the image processor 124A increases the frame rate of each of IMGA and IMGC from 60 Hz to 120 Hz. The image processor 124A may perform, for example, judder reduction processing.

The image processor 124A accesses the DRAM 199A (for example, DDR memory) via the DRAM controller 127A. The image processor 124A converts the frame rate of each of IMGA and IMGC using the DRAM 199A as a frame memory.

The image processor 124A generates IMGA′ as a result obtained by converting the frame rate of IMGA. IMGA′ s an image including interpolation frames of IMGA. The frame rate of IMGA′ is equal to the frame rate (60 Hz) of IMGA. This is the same for INGB′ to IMGD′ to be described below. IMGAf is an image in which each frame of IMGA′ is inserted between each frame of IMGA.

Similarly, the image processor 124A generates IMGC′ as a result obtained by converting the frame rate of IMGC. IMGC′ is an image including interpolation frames of IMGC. IMGCf image in which each frame of IMGC′ is inserted. between each frame of IMGC.

Subsequently, the image processor 124A performs correction (image processing) on each of IMGA, IMGA′, IMGC, and IMGC′ so as to make IMGA, IMGA′, IMGC, and IMGC′ suitable for display on the display 14. The image processor 124A outputs corrected IMGA and corrected IMGA′ to the TCON 13, as IMGAf. Further, the image processor 124A outputs corrected IMGX and corrected IMGC′ to the TCON 13, as IMGCf. That is, the image processor 124A outputs SIG4 to the TCON 13. In this way, the first back-end processor 120A processes SIG1a (first sub input image) and outputs SIG4.

As illustrated in FIG. 5(b), the second back-end processor 120B includes an input interface 121B, a format converter 122B, a synchronization circuit unit 123B, an image processor 124B, and a DRAM controller 127B. The input interface 121B generically indicates four input interfaces 12181 to 121B4. In addition, the format converter 122B generically indicates four format converters 122E1 to 122B4.

An operation of each unit of the second back-end processor 120B is the same as the operation of each unit of the first back-end processor 120A, and thus a description thereof will be omitted SIG1b and SIG2b are input to the second back-end processor 120B. The second back-end processor 120B processes one of SIG1b and SIG2b.

In the example of FIG. 5(b), the second back-end processor 120B processes SIG1b (first residual input image). The second back-end processor 120B processes SIG1b and outputs IMGBf and IMGDf to the TCON 13. That is, the second back-end processor 120B outputs SIG5.

In FIG. 4(b), IMGB′ is an image including interpolation frames of IMGB. IMGBf is an image in which each frame of IMGC′ is inserted between each frame of IMGC. In addition, IMGD′ is an image including interpolation frames of IMGD. IMGDf is an image in which each frame of IMGD′ is inserted between each frame of IMGD.

### COMPARATIVE EXAMPLE

The display apparatus 1r will be described with reference to FIG. 2. The display apparatus 1r is an example of a display apparatus in the related art. The back-end processor 12 of the display apparatus 1r is referred to as a back-end processor 12r. The back-end processor 12r includes a first back-end processor 120Ar and a second back-end processor 120Br.

In the display apparatus 1r, the first back-end processor 120Ar is configured as a master chip for image processing. On the other hand, the second back-end processor 120Br is configured as a slave chi for image processing,

Each of the first back-end processor 120Ar and the second back-end processor 12Br has a function of processing two 4K images with a frame rate of 60 Hz, similar to the first back-end processor 120A and the second back-end processor 12B. Thus, similar to the back-end processor 12r, the back-end processor 12r can process one 8K image with a frame rate of 60 Hz. That is, the back-end processor 12r can process one of SIG1 and SIG2.

On the other hand, the back-end processor 12r cannot simultaneously process both SIG1 and SIG2. Based on this point, in the display apparatus 1r, one of SIG1 and SIG2 is input to the back-end processor 12r. In order to perform such an input, in the display apparatus 1r, the switcher 19r is provided.

Both SIG1 and SIG2 are input to the switcher 19r from outside the display apparatus 1. The switcher 19r selects one of SIG1 and SIG2 to be input to the first back-end processor 120Ar. The switcher 19r supplies a selected signal as SIG3, to the first back-end processor 120Ar. In the example of FIG. 2, the switcher 19r selects SIG1. Thus, as illustrated in FIG. 3(a), SIG3 is the same signal as SIG1.

The first back-end processor 1202r divides SIG3 (SIG1) into SIG1a and SIG1b. The first back-end processor 120Ar processes SIG1a and generates SIG4. The first back-end processor 120Ar supplies SIG4 to the TCON 13.

Further, the first back-end processor 120Ar supplies a portion of SIG3 that cannot be processed by the first back-end processor 120Ar (a residual portion of SIG3) to the second back-end processor 120B. That is, the first back-end processor 120Ar supplies SIG1b to the second back-end processor 120B.

The second back-end processor 120Br processes SIG1b and generates SIG5. The second back-end processor 120Br supplies SIG5 to the TCQN 13. Thereby, SIG6 can be displayed on the display 14 as in the display apparatus 1.

(Effect)

In the display apparatus 1r (display apparatus in the related art), in a case where SIG1 and SIG2 (two 8K images) are simultaneously input to the display apparatus 1r, it is necessary to provide the switcher 19r. This is because the back-end processor 12r has a function of processing only one 8K image (for example, SIG1) (does not have a function of simultaneously processing SIG1 and SIG2).

For example, SIG1 (SIG3) is input to the first back-end processor 120Ar of the display apparatus 1r. In this case, SIG1 is divided into SIG1a and SIG1b in the first back-end processor 120Ar. Further, SIG1a is processed in the first back-end processor 120Ar, and SIG1b is processed in the second back-end processor 12013r.

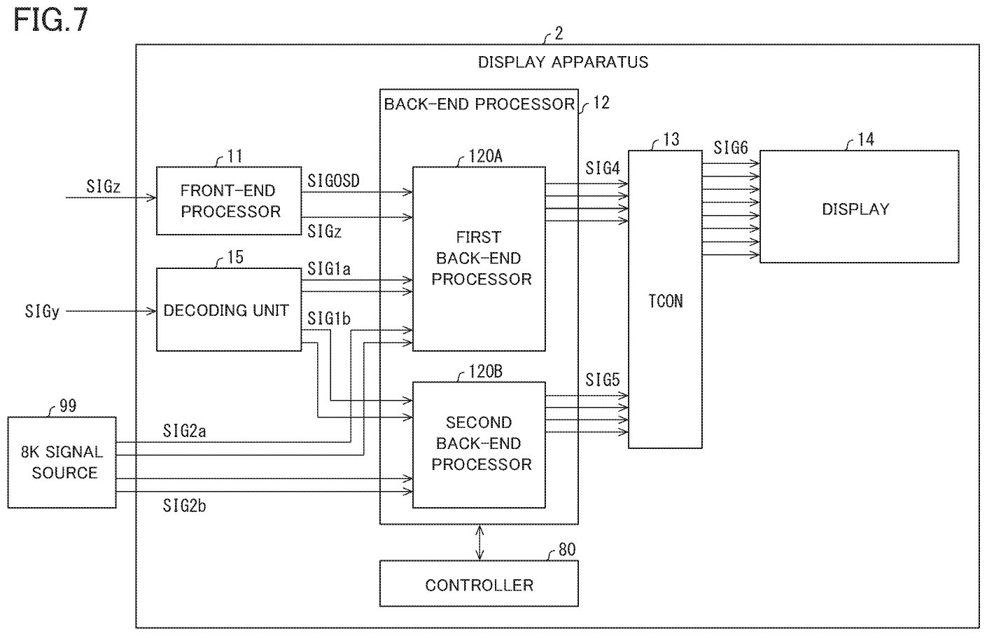

On the other band, in the display apparatus 1, (i) SIG1 is divided into SIG1a and SIG1b in advance, and (ii) SIG2 is divided into SIG2a and SIG25 in advance. SIG1 and SIG2 may be supplied to the display apparatus 1 from, for example, an 8K signal source 99 (refer to Embodiment 2 and FIG. 7 to be described later). The division of SIG1 and SIG2 may be performed in advance in the 8K signal source 99.

Further, SIG1 and S1G2 are input to the back-end processor 12 in a divided form. Specifically, SIG1a (first sub input image) and SIG2a (second sub input image) are input to the first back-end processor 120B. In addition, SIG1b (first residual input image) and SIG25 (second residual input image) are input to the second back-end processor 1208.

In this way, by supplying SIG1 and SIG2 to the display apparatus 1 (back-end processor 12) in a divided form in advance, even in a case where the switches 19r is omitted, one of SIG1 and SIG2 (for example, SIG1) can be processed in the back-end processor 12.

For example, in a case where the back-end processor 12 processes SIG1, the first back-end processor 120A processes SIG1a (first sub input image) and outputs SIG4. In addition, the second back-end processor 120B processes SIG1b (first residual input image) and outputs SIG5. In this way, SIG1 (each of SIG1a and SIG1b) can be processed by the back-end processor 12 (each of the first back-end processor 120A and the second back-end processor 120B).

According to the display apparatus 1, the switcher 19r can be omitted, and thus the configuration of the display apparatus (image processing apparatus) can be simplified as compared with the configuration in the related art. Further, a cost of the display apparatus can be reduced as compared with the cost in the related art.

(Case where Back-End Processor 12 Processes SIG2)

In the example, a case where SIG1 (first entire input image) is processed in the back-end processor 12 is described. On the other hand, SIG2 (second entire input image) may be processed in the back-end processor 12.

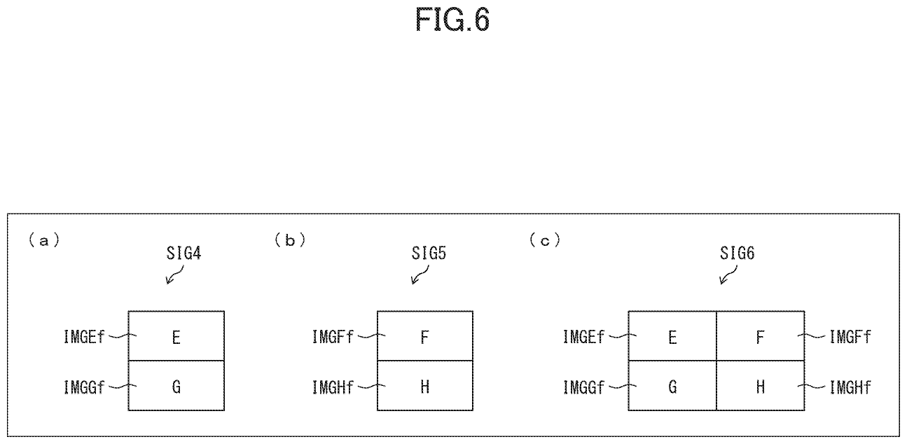

FIGS. 6(a) to 6(c) are diagrams for explaining another example of images processed by the back-end processor 12. In a case where the back-end processor 12 processes SIG2, the first back-end processor 120A processes SIG2a (second sub input image) and outputs SIG4.

As illustrated in FIG. 6(a), SIG4 is represented by a combination of IMGEf and IMGGf. IMGEf is an image obtained by converting the frame rate (60 Hz) of IMGE to 120 Hz. In addition, IMGGf is an image obtained by converting the frame rate (60 Hz) of IMGG to 120 Hz.

Further, as illustrated in FIG. 6(b), the second back-end processor 120B processes SIG2b (second residual input image) and outputs SIG5. SIG5 is represented by a combination of IMGFf and IMGHf. IMGFf is an image obtained by converting the frame rate (60 Hz) of IMGF to 120 Hz. In addition, IMGHf is an image obtained by converting the frame rate (60 Hz) of IMGH to 120 Hz.

Further, the TCON 13 supplies a signal obtained by combining SIG4 and SIG5 to the display 14, as SIG6. As illustrated in FIG. 6(c), SIG6 is represented as a combination of IMGEf to IMGHf. That is, SIG6 (entire output image) is represented as a combination of SIG4 and SIG5. In this way, as the entire output image, an image, which is obtained by converting the frame rate (60 Hz) of the second entire input image (8K image) to 120 Hz, can be obtained.

As described above, SIG2 (each of SIG2a and SIG2b) can be processed by the back-end processor 12 (each of the first back-end processor 120A and the second back-end processor 120N).

### MODIFICATION EXAMPLE

In Embodiment 1, the case where each of SIG1 and SIG2 is an 8K image is described. On the other hand, the resolution of each of SIG1 and SIG2 is not limited to 8K. Similarly, the resolution of each of IMGA to IMGD and IMGE to IMGF is not limited to 4K. Thus, each of SIG1a to SIG2b is not necessarily limited to a 4K4K image.

### Embodiment 2

FIG. 7 is a functional block diagram illustrating a configuration of a main part of a display apparatus 2 (image processing apparatus). The display apparatus 2 has a configuration in which a decoding unit 15 is added to the display apparatus 1. Further, in FIG. 7, the 8K signal source 99 provided outside the display apparatus 2 is illustrated.

The 8K signal source 99 supplies one or more 8K images (8K image signals) to the display apparatus 2. In Embodiment 2, the 8K signal source 99 supplies SIG2 to the back-end processor 12. More specifically, the 8K signal source 99 divides SIG2 into SIG2a and SIG2b. In addition, the 8K signal source 99 respectively supplies (i) SIG2a to the first back-end processor 120A and (ii) SIG2b to the second back-end processor 120B.

The decoding unit 15 acquires a compressed image signal SIGy supplied from outside the display apparatus 2. SIGy is a signal obtained by compressing SIG1. As an example, SIGy is transmitted as a broadcast wave by a provider of advanced BS broadcasting.

The decoding unit 15 acquires SIG1 by decoding he compressed image signal SIGy. In Embodiment 2, the decoding unit 15 supplies SIG1 to the back-end processor 12. More specifically, the decoding' unit 15 divides SIG1 into SIG1a and SIG1b. In addition, the decoding unit 15 respectively supplies (i) SIG1a to the first back-end processor 120A and (ii) SIG1b to the second back-end processor 120B. In this way, the image processing apparatus may have a function of decoding the compressed image signal.

### Embodiment 3

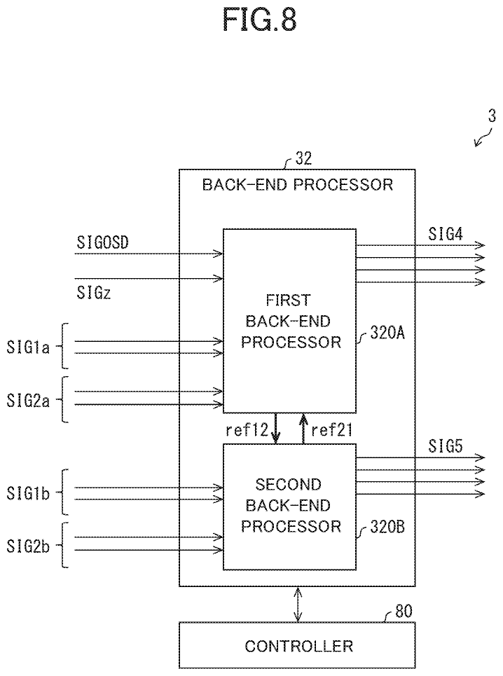

FIG. 8 is a functional block diagram illustrating a configuration of a main part of a display apparatus 3 (image processing apparatus). A back-end processor of the display apparatus 3 is referred to as a back-end processor 32. The back-end processor 32 includes a first back-end processor 320A (first image processor) and a second back-end processor 3203 (second image processor).

In FIG. 8, the same portions as those in FIG. 1 are not illustrated as appropriate. Thus, in FIG. 8, the back-end processor 32 and function blocks and signals around the back-end processor 32 are only illustrated. This is the same in the following drawings. Hereinafter, a case where the back-end processor 32 processes SIG1 (first entire input image) will be mainly described.

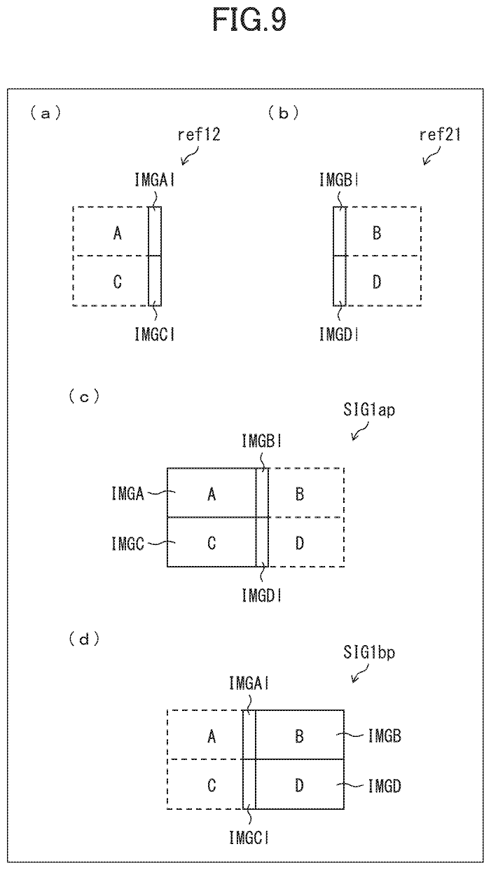

FIGS. 9(a) to 9(d) are diagrams for explaining an operation of the back-end processor 32. The first back-end processor 320A generates ref12 (first sub input boundary image) by referring to SIG1a (first sub input image). FIG. 9(a) illustrates an example of ref12. ref12 is a boundary of a right end of SIG1a. More specifically, ref12 is a boundary of SIG1a that is adjacent to SIG1b in SIG1 (first entire input image).

In Embodiment 3, a width of the “boundary” is not limited to one pixel. Thus, “an adjacent boundary” may be read as “an adjacent portion”. Therefore, “adjacent boundary processing” to be described below may be referred to as “adjacent portion processing”. As an example, a width of the boundary may be approximately 50 pixels. The number of pixels of the width of the boundary may be set according to processing (adjacent boundary processing) in the back-end processor 32.

The adjacent boundary processing is one of image processing (picture image processing) which is performed in a case where one image (for example, the first entire input image) is divided into a plurality of partial regions. Specifically, the adjacent boundary processing means “processing which is performed, in a boundary between one partial region and another partial region, on the boundary of the one divided region, by referring to pixel values of the boundary of the another partial region”.

ref12 is represented by a combination of IMGA1 and IMGC1. IMGA1 is a boundary of a right end of IMGA. More specifically, IMGA1 is a boundary of IMGA that is adjacent to IMGB STG1. Similarly, IMGC1 is a boundary of a right end of IMGC. More specifically, IMGC1 is a boundary of IMGC that is adjacent to IMGD in SIG1. The first back-end processor 320A supplies ref12 to the second back-end processor 320B.

Further, the second back-end processor 320B generates ref21 (first residual input boundary image) by referring to SIG1b (first residual input image). FIG. 8(b) illustrates an example of ref21. ref21 is a boundary of a left end of SIG1b. More specifically, ref21 is a boundary of SIG1b that is adjacent to SIG1a in SIG1.

ref21 is represented by a combination of IMGB1 and IMGD1. IMGB1 is a boundary of a left end of IMGB. More specifically, IMGB1 is a boundary of IMGB that is adjacent to IMGA in SIG1. Similarly, IMGD1 is a boundary of a left end of IMGD. More specifically, IMGD1 is a boundary of IMGD that is adjacent to IMGC in SIG1. The second back-end processor 320B supplies ref21 to the first back-end processor 320A.

ref21 is supplied from the second back-end processor 320E to the first back-end processor 320A, and thus the first back-end processor 320A can perform the adjacent boundary processing on the boundary of the right end of SIG1a (a region corresponding to ref12). That is, the first back-end processor 320A can process SIG1a by referring to ref21.

Specifically, the first back-end processor 320A generates SIG1ap by combining SIG1a and ref21. SIG1ap is an image obtained by adding ref21 (IMGB1 and IMGD1) to the right end of SIG1a. In addition, the first back-end processor 320A processes SIG1ap and outputs SIG4. That is, the first back-end processor 320A can output, as SIG4, an image obtained by performing the adjacent boundary processing on the right end of SIG1a.

Similarly, ref 12 is supplied from the first back-end processor 320A to the second back-end processor 320B, and thus the second back-end processor 320B can perform the adjacent boundary processing on the boundary of the left end of SIG1b (a region corresponding to ref21). That is, the second back-end processor 320B can process SIG1b by referring to ref12.

Specifically, the second back-end processor 320B generates SIG1bp by combining SIG1b and ref21. SIG1bp is an image obtained by adding ref12 (IMGA1 and IMGC1) to the left end of STG1b. In addition, the second back-end processor 320B processes SIG1bp and outputs SIG5. That is, the second back-end processor 320B can output, as SIG5, an image obtained by performing the adjacent boundary processing on the left end of SIG1b.

The display apparatus 3 can perform the adjacent boundary processing on each of SIG1a and SIG1b. Thus, SIG4 and SIG5 having a further excellent display quality can be provided. Thereby, SIG6 having a further excellent display quality can be provided. Particularly, in a portion corresponding to the boundary between SIG1a and SIG1b, the display quality of SIG6 can be improved.

### MODIFICATION EXAMPLE

The back-end processor 32 can also process SIG2 (second entire input image). In this case, the first back-end processor 320A generates ref12 as a second sub input boundary image by referring to SIG2a (second sub input image). In this case, ref12 is a boundary of SIG2a that is adjacent to SIG2b in SIG2. ref12 is a boundary of a right end of SIG2a. The first back-end processor 320A supplies ref12 to the second back-end processor 320B.

Similarly, the second back-end processor 320B generates ref12 as a second residual input boundary image by referring to SIG2b (second sub input image). In this case, ref21 is a boundary of SIG2b that is adjacent to SIG2a in SIG2. ref21 is a boundary of a left end of SIG2b. The second back-end processor 320B supplies ref21 to the first back-end processor 320A.

Thereby, the first back-end processor 320A can process SIG2a by referring to ref21. Similarly, the second back-end processor 3205 can process SIG2b by referring to ref12.

### Embodiment 4

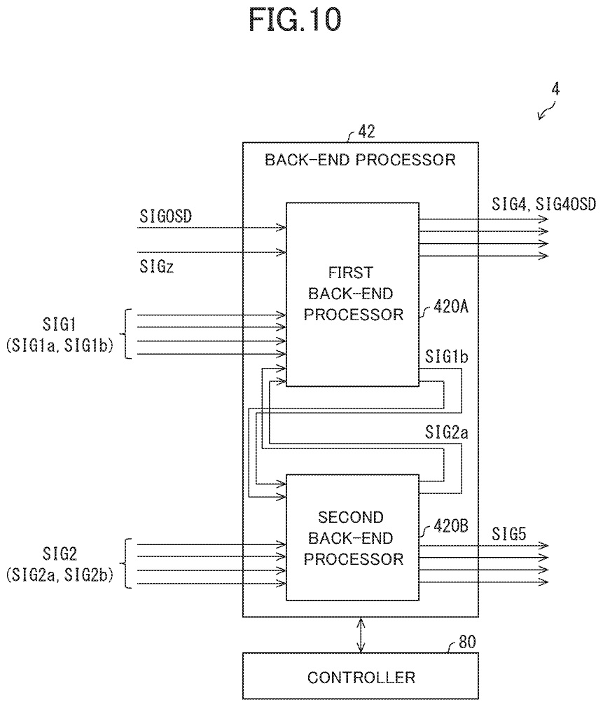

FIG. 10 is a functional block diagram illustrating a configuration of a main part of a display apparatus 4 (image processing apparatus). A back-end processor of the display apparatus 4 is referred to as a back-end processor 42. The back-end processor 42 includes a first back-end processor 420A (first image processor) and a second back-end processor 420E (second image processor).

SIG1 is input to the first back-end processor 420A. In addition, SIG2 is input to the second back-end processor 420B. That is, in Embodiment 4, unlike Embodiments 1 to 3. SIG1 and SIG2 are not supplied to the display apparatus 4 (the back-end processor 42) in a divided form in advance. As described above, in Embodiment 4, an input relationship of signals to the back-end processor (the first back-end processor and the second back-end processor) is different from that in Embodiments 1 to 3. The back-end processor 42 processes one of SIG1 and SIG2.

(Case where Back-End Processor 42 Processes SIG1)

The first back-end processor 420A divides SIG1 into SIG1a and SIG1b. The first back-end processor 420A processes SIG1a (that is, two predetermined first partial input images) and outputs SIG4. The first back-end processor 420A outputs SIG4 to the TCON 13. Further, the first back-end processor 420A supplies SIG1b (two remaining first partial input images obtained by excluding the two predetermined first partial input images) to the second back-end processor 420B.

The second back-end processor 420B processes SIG1b supplied from the first back-end processor 420A, and generates SIG5. The second back-end processor 4208 supplies SIG5 to the TCON 13. Thereby, SIG6 as a display image corresponding to SIG1 can be supplied to the display 14.

(Case where Back-End Processor 42 Processes SIG2)

The second back-end processor 420B divides SIG2 into SIG2a and SIG2b. The second back-end processor 420B processes SIG2b (that is, two predetermined second partial input images) and generates SIG5. The second back-end processor 420B outputs SIG5 to the ICON 13. Further, the second back-end processor 420B supplies SIG2a (two remaining second partial input images obtained by excluding the two predetermined second partial input images) to the first back-end processor 420A.

The first back-end processor 420A processes SIG2a supplied from the second back-end processor 120B, and generates SIG4. The first back-end processor 420A supplies SIG4 to the TCON 13. Thereby, SIG6 as a display image corresponding to SIG2 can be supplied to the display 14.

As described above, in the display apparatus 4, the second back-end processor 420B supplies SIG2a (the residual portion of SIG2) to the first back-end processor 420A. The display apparatus 4 is different from the display apparatus 1r (the comparative example of FIG. 2) in this point. In the display apparatus 1r, an output destination of the switcher 19r is fixed to the first back-end processor 120Ar. This is because, in the display apparatus 1r, the first back-end processor 120Ar is a master chip for image processing.

In the display apparatus 1r, the second back-end processor 120Br is a slave chip for image processing. For this reason, in the display apparatus 1r, the second back-end processor 120Br only receives, for example, a part of SIG1 (for example, SIG1b) from the first back-end processor 120Ar. The second back-end processor 120Br (slave chip) is not configured to supply a part of the signal received by the own second back-end processor 120Br to the first back-end processor 120Ar (master chip).

On the other hand, in the display apparatus 4, SIG2a can be supplied from the second back-end processor 420B to the first back-end processor 420A. Even in the display apparatus 4, similar to Embodiments 1 to 3, even in a case where the switcher 19r is omitted, one of SIG1 and SIG2 can be processed by the back-end processor 42. That is, according to the display apparatus 4, the configuration of the image processing apparatus can be simplified as compared with that in the related art.

(Another Effect of Display Apparatus 4)

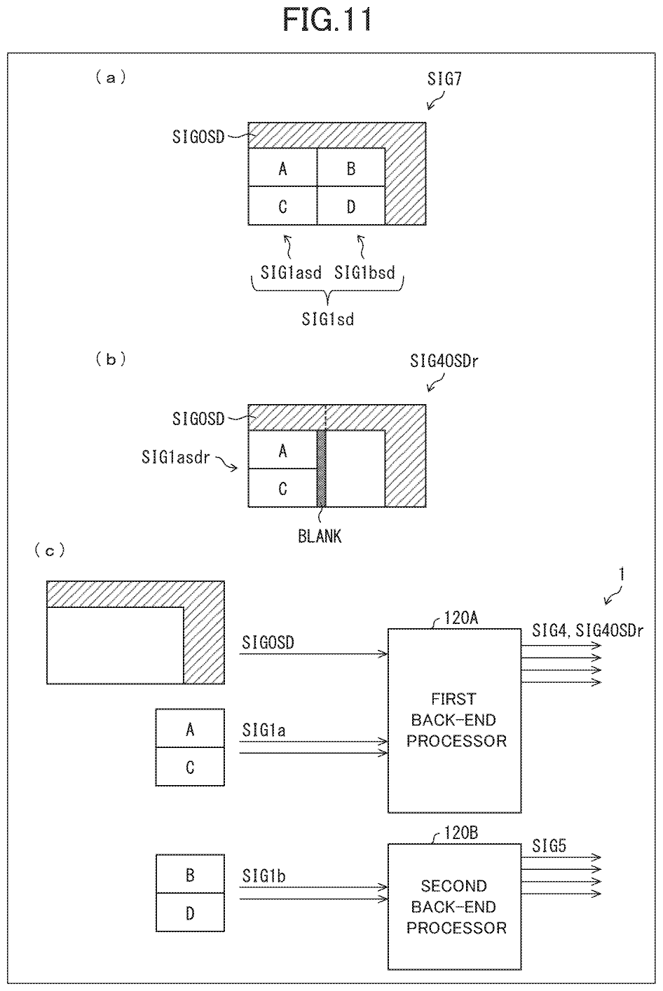

FIGS. 11(a) to 11(c) are diagrams for explaining another effect of the display apparatus 4. As illustrated in FIG. 11(a), for example, a user may desire that an image (SIG7) which is obtained by superimposing an image (SIG1sd) obtained by reducing SIG1 and SIGOSD (OSD image) is displayed on the display 14. SIG1sd includes an image (SIG1asd) obtained by reducing SIG1a and an image (SIG1bsd) obtained by reducing SIG1b.

In such a case, the first back-end processor 420A needs to superimpose SIG4 and SIGOSD. Hereinafter, a signal obtained by superimposing 3IG4 and SIGOSD is referred to as SIG4OSD.

In Embodiment 4, SIG1 (that is, both SIG1a and SIG1b) is input to the first back-end processor 420A. Thus, the first back-end processor 420A can appropriately reduce SIG1 according to a size and a shape (position) of SIGOSD, and generate SIG1sd (that is, both SIG1asd and SIG1bsd). Therefore, SIG4OSD can be generated such that BLANK (a blank region) to be described below does not occur. BLANK may be referred to as a non-display region.

Thereby, in the display apparatus 4, SIG7 can be obtained by combining SIG4OSD and SIG5. Therefore, even in a case where an OSD image is superimposed, a display image having a high display quality can be provided. The configuration of the display apparatus 4 is considered based on improvable points in Embodiments 1 to 3, and the improvable points will be described below.

FIGS. 11(b) and 11(c) are diagrams for explaining improvable in Embodiments 1 to 3 (for example, the display apparatus 1 according to Embodiment 1). As illustrated in FIG. 11(b) , in the display apparatus 1, for example, in an image (referred to as SIG4OSDr for a comparison with Embodiment 4) which is obtained by superimposing an image (referred to as SIG1asdr for a comparison with Embodiment 4) obtained by reducing SIG1a and SIGOSD, BLANK occurs. The reason will be described.

As illustrated in FIG. 11(c), in the display apparatus 1, only SIG1a is input to the first back-end processor 120A. In addition, SIG1b is not supplied from the second back-end processor 120B to the first back-end processor 120A. As a result, when the first back-end processor 120A reduces SIG1a, BLANK occurs in SIG4OSDr. BLANK is a region at which a left end of SIG1bsd should be originally displayed. Since the first back-end processor 120A cannot refer to SIG1b, BLANK. occurs due to reduction of SIG1a.

(Supplement)

The image processing apparatus according to Embodiment 4 can be represented as follows. According to an aspect of the present disclosure, there is provided an image display apparatus including a first image processor and a second image processor, in which a first entire input image is constituted by combining a first sub input image and a first residual input image, which a second entire input image is constituted by combining a second sub input image and a second residual input image, in which the first entire input image is input to the first image processor, in which the second entire input image is input to the second image processor, in which the first image processor supplies the first residual input image included in the first entire input image to the second image processor, and in which the second image processor supplies the second sub input image included in the second entire input image to the first image processor. The image processing apparatus processes one of the first entire input image and the second entire input image. In a case where the image processing apparatus processes the first entire input image, the first image processor processes the first sub input image included in the first entire input image, and the second image processor processes the first residual input image supplied from the first image processor. In a case where the image processing apparatus processes the second entire input image, the first image processor processes the second sub input image supplied from the second image processor, and the second image processor processes the second residual input image included in the second entire input image.

### Embodiment 5

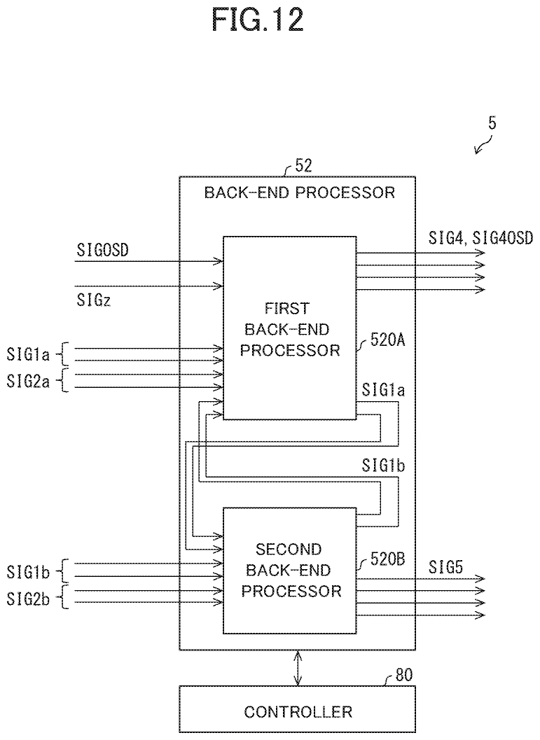

FIG. 12 is a functional block diagram illustrating a configuration of a main part of a display apparatus 5 (image processing apparatus). A back-end processor of the display apparatus 5 is referred to as a back-end processor 52. The back-end processor 52 includes a first back-end processor 520A (first image processor) and a second back-end processor 520B (second image processor).

Similar to Embodiment 1, SIG1a and SIG2a are input to the first back-end processor 520A. Further, similar to Embodiment 1, SIG1b and SIG2b are input to the second back-end processor 520B. The back-end processor 52 processes one of SIG1 and SIG2.

(Case where Back-End Processor 52 Processes SIG1)

The first back-end processor 520A supplies SIG1a to the second back-end processor 520B. Further, the second back-end processor 520B supplies SIG1b to the first back-end processor 520A.

The first back-end processor 520A processes SIG1a by referring to SIG1b acquired from the second back-end processor 520B. The first back-end processor 520A generates SIG4 as a result obtained by processing SIG1a. The first back-end processor 520A supplies SIG4 to the TCON 13.

The second back-end processor 520B processes SIG1b by referring to SIG1a acquired from the first back-end processor 520A. The second back-end processor 520B generates SIG5 as a result obtained by processing SIG1b. The second back-end processor 520B supplies SIG5 to the TCON 13. Thereby, SIG6 as a display image corresponding to SIG1 can be supplied to the display 14.

(Case where Back-End Processor 52 Processes SIG2)

The first back-end processor 520A supplies SIG2a to the second back-end processor 520B. Further, the second back-end processor 520B supplies SIG2b to the first back-end processor 520A.

The first back-end processor 520A processes SIG2a by referring to SIG2b acquired from the second back-end processor 520B. The first back-end processor 520A generates SIG4 as a result obtained by processing SIG2a. The first back-end processor 520A supplies SIG4 to the TCON 13.

The second back-end processor 520B processes SIG2b by referring to SIG2a acquired from the first back-end processor 520A. The second back-end processor 520B generates SIG5 as a result obtained by processing SIG2b. The second back-end processor 520B supplies SIG5 to the ICON 13. Thereby, SIG6 as a display image corresponding to SIG2 can be supplied to the display 14.

Even in Embodiment 5, similar to Embodiment 4, SIG1 (that is, both SIG1a and SIG1b) is input to the first back-end processor 520A. Thus, similar to Embodiment 4, the first back-end processor 520A can generate SIG4OSD such that BLANK does not occur. Therefore, even in a case where an OSD image is superimposed, a display image having a high display quality can be provided.

### Embodiment 6

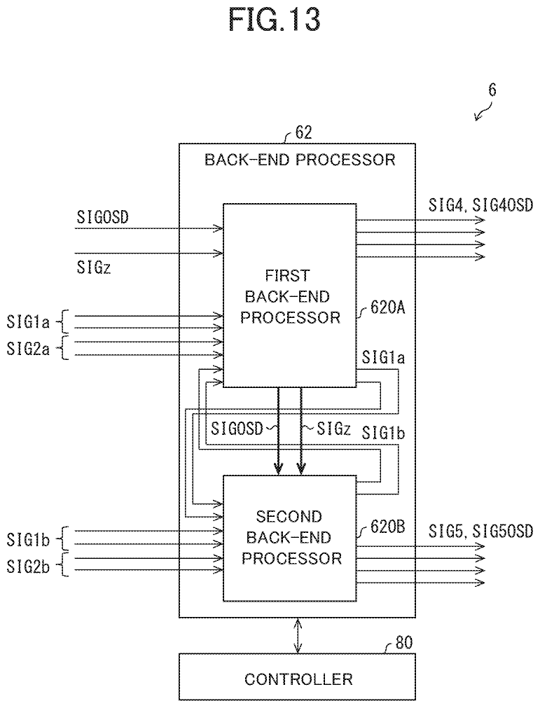

FIG. 13 is a functional block diagram illustrating a configuration of a main part of a display apparatus 6 (image processing apparatus). A back-end processor of the display apparatus 6 is referred to as a back-end processor 62. The back-end processor 62 includes a first back-end processor 620A (first image processor) and a second back-end processor 620B (second image processor).

In Embodiment 6, an input/output relationship between SIG1 and SIG2 (SIG1a to SIG2b) is the same as that in Embodiment 5. In Embodiment 6, the first back-end processor 620A supplies SIGOSD and SIGz to the second back-end processor 620B. Thus, even in the second back-end processor 620B, the OSD image can be also superimposed in the same manner as that in the first back-end processor 620A. In this point, the configuration of Embodiment 6 is different from those in Embodiments 4 and 5.

The second back-end processor 620B can generate SIG5OSD as a signal obtained by superimposing SIG5 and SIGOSD. Similar to the first back-end processor 620A, the second back-end processor 620B can generate SIG5OSD such that BLANK does not occur. Therefore, even in a case where an OSD image is superimposed, a display image having a high display quality can be provided.

(Input/Output Port of Back-End Processor)

The back-end processor according to an aspect of the present disclosure (for example, the back-end processor 62) includes a plurality of ports for inputting and outputting an image. On the other hand, the input/output interface is not always the same between the back-end processor 62 and other functional units. This is because, although at least a part of each functional unit of the display apparatus 6 is realized by, for example, a large scale integrated (LSI) chip, the input/output interface between each functional unit (each LSI chip) is not always the same.

As an example, for (i) an input of each of signals (SIGOSD and SIGz) from the front-end processor 11 to the back-end processor 62 and (ii) an output of each of signals (SIG4 and SIG5) from the back-end processor 62 to the TCON 13, an inter-LSI transmission interface is used. In addition, for an input and an output of each of signals (for example, SIG1a and SIG1b) between the first back-end processor 620A and the second back-end processor 620B, an inter-LSI transmission interface is also used. Examples of the inter-LSI transmission interface include V-by-One HS, embedded display port (eDP), low voltage differential signaling (LVDS), mini-LVDS, and the like.

On the other hand, for an input of each of signals (SIG1a to SIG2b) from the 8K signal source 99 to the back-end processor 62, an inter-apparatus transmission interface is used. Examples of the inter-apparatus transmission interface include a High-Definition Multimedia interface (HDMI) (registered trademark), a display port, and the like. Therefore, in the image processing apparatus according to an aspect of the present disclosure, each of the first back-end processor and the second back-end processor is designed to include both the inter-LSI transmission interface and the inter-apparatus transmission interface.

### Embodiment 7

In Embodiments 1 to 6, the case where the first sub input image and the first residual input image respectively constitute a half (½) of the first entire input image is described. That is, the case where the first entire input image is divided by half is described.

On the other hand, the first entire input image may be unevenly divided. That is, the first sub input image and the first residual input image may be images having different sizes. This is the same for the second entire input image (the second sub input image and the second residual input image).

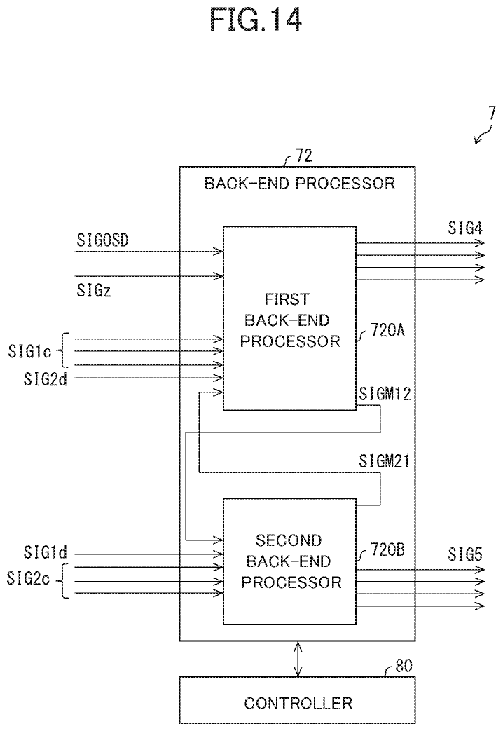

FIG. 14 is a functional block diagram illustrating a configuration of a main part of a display apparatus 7 (image processing apparatus). A back-end processor of the display apparatus 7 is referred to as a back-end processor 72. The back-end processor 72 includes a first back-end processor 720A (first image processor) and a second back-end processor 720B (second image processor).

In Embodiment 7, SIG1 (first entire input image) is constituted by SIG1c (first sub input image) and SIG1d (first residual input image). Similarly, SIG2 (second entire input image) is constituted by SIG2c (second sub input image) and SIG1d (second residual input image).

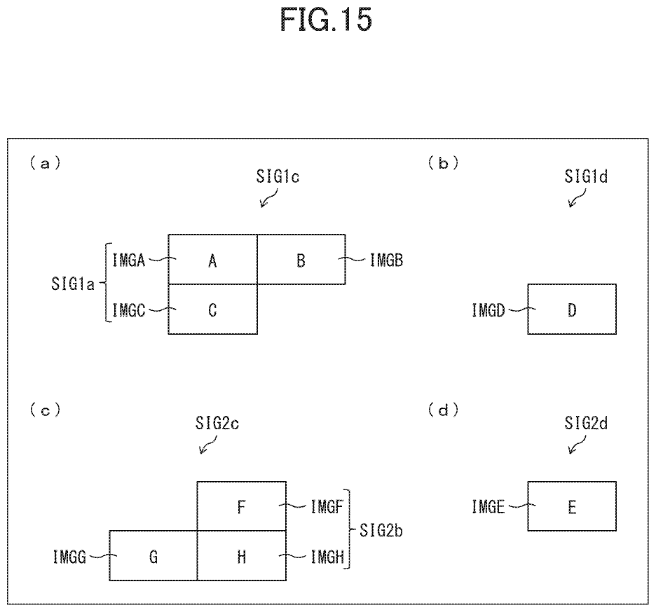

FIGS. 15(a) to 15(d) are diagrams for explaining images which are input to the back-end processor 72. As illustrated in FIG. 15(a), SIG1c includes IMGA to IMGC (three 4K images). In other words, SIG1c is an image in which IMGB is further added to SIG1a. In this way, SIG1c constitutes ¾ of SIG1. On the other hand, as illustrated in FIG. 15(b), SIG1d includes only IMGD (one 4K image). In other words, SIG1d is an image obtained by excluding IMGB from SIG1b. In this way, SIG1d constitutes ¼ of SIG1.

Similarly, as illustrated in FIG. 15(c), SIG2c includes IMGF to IMGH (three 4K images). In other words, SIG2c is an image in which IMGG is further added to SIG2b. In this way, SIG2c constitutes ¾ of SIG2. On the other hand, as illustrated in FIG. 15(d), SIG2d includes only IMGE (one 4K image). In other words, SIG2d is an image obtained by excluding IMGG from SIG2a. In this way, SIG2d constitutes ¼ of SIG2.

As illustrated in FIG. 14, SIG1c and SIG2d are input to the first back-end processor 720A. Further, SlG1d and SIG2c are input to the second back-end processor 720B. The back-end processor 72 processes one of SIG1 and SIG2.

(Case where Back-End Processor 72 Processes SIG1)

The first back-end processor 720A divides SIG1c into IMGA to IMGC (three first partial input images). The first back-end processor 720A generates SIG4 by processing IMGA and IMGC (two predetermined first partial input images among the three first partial input images) (SIG1a). The first back-end processor 720A supplies SIG4 to the TCON 13.

Further, the first back-end processor 720A supplies IMGB to the second back-end processor 720B, as SIGM12. SIGM12 means an image that is not selected as a target of processing of the first back-end processor 720A among the images acquired by the first back-end processor 720A (the one remaining first partial input image excluding the two predetermined first partial input images).

The second back-end processor 720B processes (i) SIGM12 (IMGB) acquired from the first back-end processor 720A and (ii) SIG1d (IMGD) (one first partial input image which is not input to the first back-end processor 720A). In this way, the second back-end processor 720B generates SIG5 by processing IMGB and IMGD (that is, the two remaining first partial input images) (SIG1b). The second back-end processor 720B supplies SIG5 to the TCON 13. Thereby, SIG6 as a display image corresponding to SIG1 can be supplied to the display 14.

(Case where Back-End Processor 72 Processes SIG2)

The second back-end processor 720B divides SIG2c into IMGF to IMGH (three first partial input images). The second back-end processor 720B generates SIG5 by processing IMGF and IMGH (two predetermined second partial input images among the three second partial input images) (SIG2b). The second back-end processor 720B supplies SIG5 to the TCON 13.

Further, the second back-end processor 720B supplies IMGG to the first back-end processor 720A, as SIGM21. SIGM21 means an image that is not selected as a target of processing of the second back-end processor 720B among the images acquired by the second back-end processor 720B (the one remaining second partial input image excluding the two predetermined second partial input images).

The first back-end processor 720A processes (i) SIGM21 (IMGG) acquired from the first back-end processor 720A and (ii) SIG2d (IMGE) (one second partial input image which is not input to the second back-end processor 720B). In this way, the second back-end processor 720B generates SIG5 by processing IMGB and IMGD (that is, the two remaining second partial input images) (SIG2a). The second back-end processor 720B supplies SIG5 to the TCON 13. Thereby, SIG6 as a display image corresponding to SIG2 can be supplied to the display 14.

Even in the display apparatus 7, similar to Embodiments 1 to 6, even in a case where the switcher 19r is omitted, one of SIG1 and SIG2 can be processed by the back-end processor 72. That is, according to the display apparatus 7, the configuration of the image processing apparatus can be simplified as compared with that in the related art.

The configuration of Embodiment 7 is similar to the configuration of Embodiment 4 in that “an image, which is not a target of processing (an image which is not processed) by one image processor (for example, the first back-end processor) among two image processors, is supplied from the one image processor to the other image processor (for example, the second back-end processor)”.

On the other hand, in Embodiment 4, four first partial input images (IMGA to IMGD) are input to the first back-end processor. Further, four second partial input images (IMGE to IMGH) are input to the second back-end processor. For convenience, a mode for inputting the first entire input image and the second entire input image to the first back-end processor and the second back-end processor in Embodiment 4 will be referred to as an “input mode 1”. In the input mode 1, four first partial input images (for example, IMGA to IMGD) are input to the first back-end processor, and tour second partial input images (for example, IMGE IMGH) are input to the second back-end processor.

On the other hand, a mode for inputting the first entire input image and the second entire input image to the first back-end processor and the second back-end processor in Embodiment 7 will be referred to as an “input mode 2”. In the input mode 2, three first partial input images (for example, IMGA to IMGC) and one second partial input image (for example, IMGE) (second partial input image which is not input to the second back-end processor among four second partial input images) are input to the first back-end processor. Further, one first partial input image (for example, IMGD) (first partial input image which is not input to the first back-end processor among four first partial input images) and three second partial input images (for example, IMGF to IMGH) are input to the second back-end processor.

As described above, the configuration of Embodiment 7 is different from the configuration of Embodiment 4 in at least the input mode. In modification examples and Embodiment 8 to be described below, variations of the image processing apparatus in a case where the input mode 2 is adopted will be described.

### MODIFICATION EXAMPLE

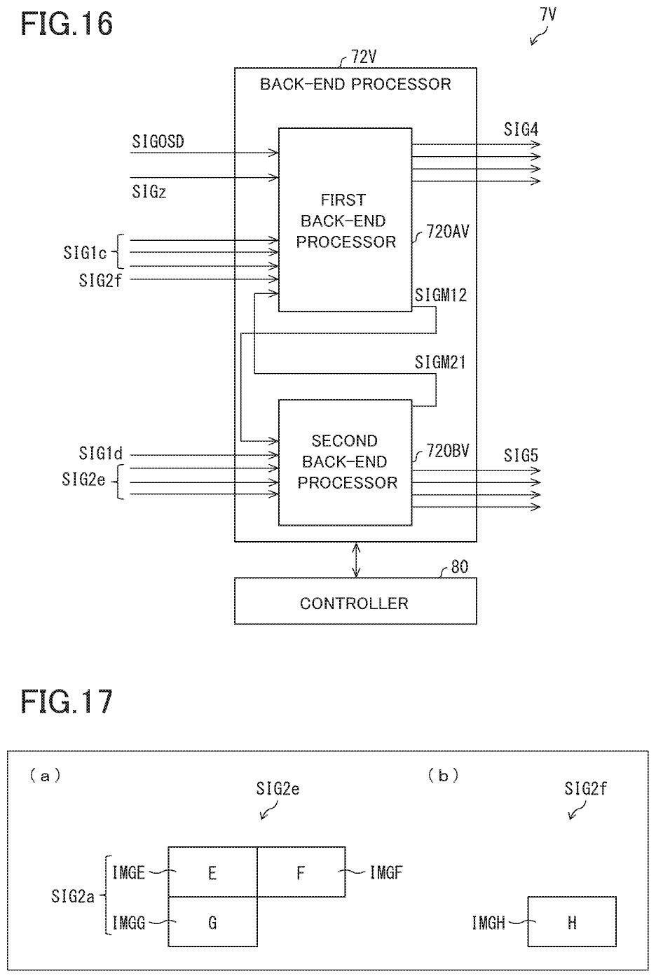

FIG. 16 is a functional block diagram illustrating a configuration of a main part of a display apparatus 7V (image processing apparatus) according to a modification example of Embodiment 7. A back-end processor of the display apparatus 7V is referred to as a back-end processor 72V. The back-end processor 72V includes a first back-end processor 720AV (first image processor) and a second back-end processor 720BV (second image processor).

A combination of the first partial input images and the second partial input images which are input to the first back-end processor and the second back-end processor is not limited to the example of Embodiment 7. As an example, in the display apparatus 7V, SIG2 is constituted by SIG2e (second sub input image) and SIG1f (second residual input image). According to the display apparatus 7V, the same effect as that in the display apparatus 7 can be obtained. The same applies to a display apparatus 8 to be described later.

FIGS. 17(a) and 17(b) are diagrams for explaining images which are input to the back-end processor 72V. As illustrated in FIG. 17(a), SIG1e includes IMGE to IMGG (three 4K images). In other words, SIG1e is an image in which IMGF is further added to SIG2a. On the other hand, as illustrated in FIG. 17(b), SIG2f includes only IMGH (one 4K image). Ia other words, SIG2f is an image obtained by excluding IMGF from SIG2b.

As illustrated in FIG. 17, SIG1c and SIG2f are input to the first back-end processor 720AV. Further, SIG1d and SIG2e are input to the second back-end processor 720EV. The back-end processor 72V processes one of SIG1 and SIG2.

(Case where Back-End Processor 72V Processes SIG1)

The first back-end processor 720AV divides SIG1c into IMGA to IMGC (three first partial input images). The first back-end processor 720AV generates SIG4 by processing IMGA. and IMGB (two predetermined first partial input images among the three first partial input images). The first back-end processor 720A supplies SIG4 to the TCON 13.

Further, the first back-end processor 720AV supplies IMGC to the second back-end processor 720BV, as SIGM12 (the one remaining first partial input image excluding the two predetermined first partial input images).

The second back-end processor 720BV processes (i) SIGM12 (IMGC) acquired from the first back-end processor 720AV and (ii) SIG1d (IMGD) (one first partial input image which is not input to the first back-end processor 720AV). In this way, the second back-end processor 720BV generates SIG5 by processing IMGC and IMGD (that is, the two remaining first partial input images). The second back-end processor 720BV supplies SIG5 to the TCON 13. Thereby, SIG6 as a display image corresponding to SIG1 can be supplied to the display 14.

(Case where Back-End Processor 72V Processes S1G2)

The second back-end processor 720BV divides SIG2e into IMGE to IMGG (three second partial input images). The second back-end processor 720BV generates SIG5 by processing IMGE and IMGF (two predetermined second partial input images among the three second partial input images). The second back-end processor 720E supplies SIG5 to the TOON 13.

Further, the second back-end processor 720EV supplies IMGG to the first back-end processor 720AV, as SIGM21 (the one remaining second partial input image excluding the two predetermined second partial input images).

The first back-end processor 720AV processes (i) SIGM21 (IMGG) acquired from the second back-end processor 720BV and (ii) SIG2f (IMGH) (one second partial input image which is not input to the second back-end processor 720BV). In this way, the first back-end processor 720AV generates SIG4 by processing IMGG and IMGH (that is, the two remaining second partial input images). The first back-end processor 720AV supplies SIG4 to the TOON 13. Thereby, SIG6 as a display image corresponding to SIG2 can be supplied to the display 14.

### Embodiment 8

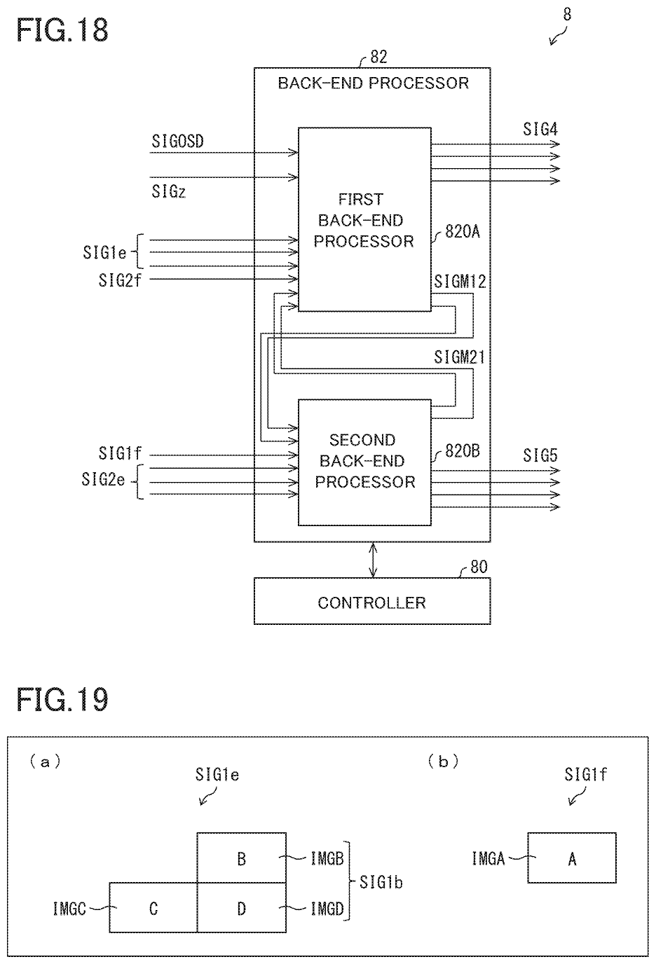

FIG. 18 is a functional block diagram illustrating a configuration of a main part of a display apparatus 8 (image processing apparatus). A back-end processor of the display apparatus 8 is referred to as a back-end processor 82. The back-end processor 82 includes a first back-end processor 820A (first image processor) and a second back-end processor 8203 (second image processor).

In Embodiment 8, SIG1 is constituted by SIG1e (first sub input image) and SIG1f (first residual input image). Further, similar to the case of FIG. 16, SIG2 is constituted by SIG2e and SIG2f.

FIGS. 19(a) and 19(b) are diagrams for explaining images which are input to the back-end processor 82. As illustrated in FIG. 19(a), SIG2e includes IMGB to IMGD (three 4K images). In other words, SIG2e is an image in which IMGC is further added to SIG1b. On the other hand, as illustrated in FIG. 19(b), SIG1f includes only IMGA (one 4K image). In other words, SIG1f is an image obtained by excluding IMGb from SIG1a.

As illustrated in FIG. 18, SIG1e and SIG2f are input to the first back-end processor 820A. Further, SIG1e and SIG2e are input to the second back-end processor 8205. The back-end processor 82 processes one of SIG1 and SIG2.

(Case where Back-End Processor 82 Processes SIG1)

The first back-end processor 820A divides SIG1e into IMGB to IMGD (three first partial input images). Further, the first back-end processor 820A acquires SIGM21 (IMGA) from the second back-end processor 8205.

The first back-end processor 820A processes (i) SIGM21 (IMGA) acquired from the second back-end processor 820B and (ii) IMGC (a predetermined first partial input image among the three first partial input images). In this way, the first back-end processor 820A generates SIG4 by processing IMGA and IMGC (that is, two first partial input images) (SIG1a). The first back-end processor 720A supplies SIG4 to the TCON 13.

Further, the first back-end processor 820A supplies IMGB and IMGD to the second back-end processor 820B, as SIGM12 (two first partial input images excluding the predetermined first partial input image).

The second back-end processor 820B generates SIG5 by processing SIGM12 (IMGB and IMGD) (SIG1b) acquired from the first back-end processor 720A. The second back-end processor 820B supplies SIG5 to the TCON 13. Thereby, SIG6 as a display image corresponding to SIG1 can be supplied to the display 14.

Further, the second back-end processor 820B supplies IMGA (SIG1f) to the first back-end processor 820A, as SIGM21.

(Case where Back-End Processor 82 Processes SIG2)

The second back-end processor 820B divides SIG2e into IMGE to IMGG (three second partial input images). Further, the second back-end processor 820B acquires SIGM12 (IMGH) from the first back-end processor 820A.

The second back-end processor 820B processes (i) SIGM12 (IMGH) acquired from the first back-end processor 820A and (ii) IMGF (a predetermined second partial input image among the three first partial input images). In this way, the second back-end processor 820B generates SIG5 by processing IMGF and IMGH (that is, two second partial input images) (SIG2b). The second back-end processor 820B supplies SIG 5 to the TCON 13.

Further, the second back-end processor 820B supplies IMGE and IMGG to the first back-end processor 820A, as SIGM21 (two second partial input images excluding the predetermined second partial input image).

The first back-end processor 820A generates SIG4 by processing SIGM21 (IMGE and IMGG) (SIG2a) acquired from the second back-end processor 820A. The first back-end processor 820A supplies SIG4 to the TCON 13. Thereby, SIG6 as a display image corresponding to SIG2 can be supplied to the display 14.

Further, the first back-end processor 820A supplies IMGH (SIG2f) to the second back-end processor 820B, as SIGM12.

(Supplement)

The image processing apparatuses according to Embodiments 4, 7, and 8 are common in the following (1) and (2).

(1) In a case where the image processing apparatus processes the first entire input image, the first image processor (i) processes the one or more predetermined first-unit input images among the three or more first-unit input images which are input to the first image processor, and (ii) supplies the remaining first-unit input image excluding the one or more predetermined first-unit input images, to the second image processor. Further, the second image processor processes at least one of (i) the one first-snit input image which is not input to the first image processor and (ii) the remaining first-unit input image supplied from the first image processor.

(2) in a case where the image processing apparatus processes the second entire input image, the second image processor (i) processes the one or more predetermined second-unit input images among the three or more second-unit input images which are input to the second image processor; and (ii) supplies the remaining second-unit input image excluding the one or more predetermined second-unit input images, to the first image processor, and the first image processor processes at least one of (i) the one second-unit input image which is not input to the second image processor and (ii) the remaining second-unit input image supplied from the second image processor.

[Example of Implementation by Software]

The control blocks (specially, the back-end processors 12 to 82) of the display apparatuses 1 to 8 may be realized by logic circuits (hardware) formed on an integrated circuit (IC chip), or may be realized by software.

In the latter case, the display apparatuses 1 to 8 include a computer that executes instructions of a program. as software for realizing each function. The computer includes, for example, at least one processor (control device) and at least one computer-readable recording medium in which the program is stored. Further, in the computer, the object of an aspect of the present disclosure is achieved by causing the processor to read the program from the recording medium and execute the program. As the processor, for example, a central processor (CPU) may be used. As the recording medium, a “non-transitory tangible medium”, for example, a read only memory (ROM), a tape, a disk, a card, a semiconductor memory, a programmable logic circuit, or the like may be used. In addition, a random access memory (RAM) for loading the program may be further provided. Further, the program may be supplied to the computer via a certain transmission medium (a communication network, a broadcast wave, or the like) through which the program can be transmitted. An aspect of the present disclosure can also be realized in a form in which the program is implemented by electronic transmission, for example, in a form of a data signal embedded on a carrier wave.

(Summary)

According to an aspect 1 of the present disclosure, there is provided an image processing apparatus (display apparatus 1) including: a first image processor (first back-end processor 120A); and a second image processor (second back-end processor 120B), in which a first entire input image (SIG1) is constituted by combining a first sub input image (SIG1a) and a first residual input image (SIG1b), in which a second entire input image (SIG2) is constituted by combining a second sub input image (SIG2a) and a second residual input image (SIG2b), in which the first sub input image and the second sub input image are input to the first image processor, in which the first residual input image and the second residual input image are input to the second image processor, in which the image processing apparatus processes one of the first entire input image and the second entire input image, in which, in a case where the image processing apparatus processes the first entire input image, the first image processor processes the first sub input image, and the second image processor processes the first residual input image, and in which, in a case where the image processing apparatus processes the second entire input image, the first image processor processes the second sub input image, and the second image processor processes the second residual input image.

According to the configuration, unlike the image processing apparatus in the related art, in a case where the first entire input image and the second entire input image (for example, two 8K images) are simultaneously input to the image processing apparatus, a switcher can be omitted. Therefore, the configuration of the image processing apparatus can be simplified as compared with the configuration in the related art.

According to an aspect 2 of the present disclosure, in the image processing apparatus according to the aspect 1, in the first entire input image, a boundary of the first sub input image that is adjacent to the first residual input image may be set as a first sub input boundary image, and a boundary of the first residual input image that is adjacent to the first sub input image may be set as a first residual input boundary image, in a case where the image processing apparatus processes the first entire input image, the first image processor may supply the first sub input boundary image to the second image processor, the second image processor may supply the first residual input boundary image to the first image processor, the first image processor may process the first sub input image by referring to the first residual input boundary image supplied from the second image processor, and the second image processor may process the first residual input image by referring to the first sub input boundary image supplied from the first image processor. Further, in the second entire input image, a boundary of the second sub input image that is adjacent to the second residual input image may be set as a second sub input boundary image, and a boundary of the second residual input image that is adjacent to the second sub input image may be set as a second residual input boundary image, and in a case where the image processing apparatus processes the second entire input image, the first image processor may supply the second sub input boundary ,mage to the second image processor, the second image processor may supply the second residual input boundary image to the first image processor, the first image processor may process the second sub input image by referring to the second residual input boundary image supplied from the second image processor, and the second image processor may process the second residual input image by referring to the second sub input boundary image supplied from the first image processor.

According to the configuration, adjacent boundary processing can be performed on, for example, each of the first sub input image and the first residual input image. Therefore, a display quality of the first entire input image can be further improved by the image processing.

According to an aspect 3 of the present disclosure, in the image processing apparatus according to the aspect 1 or 2, in a case where the image processing apparatus processes the first entire input image, the first image processor may supply the first sub input image to the second image processor, the second image processor may supply the first residual input image to the first image processor, the first image processor may process the first sub input image referring to the first residual input image supplied from the second image processor, and the second image processor may process the first residual input image by referring to the first sub input image supplied from the first image processor. Further, in a case where the image processing apparatus processes the second entire input image, the first image processor may supply the second sub input image to the second image processor, the second image processor may supply the second residual input image to the first image processor, the first image processor may process the second sub input image by referring to the second residual input image supplied from the second image processor, and the second image processor may process the second residual input image by referring to the second sub input image supplied from the first image processor.

According to the configuration, in the first back-end processor, an OSD image can be appropriately superimposed.

According to an aspect 4 of the present disclosure, in the image processing apparatus according to the aspect 3, the first image processor may acquire an on screen display (OSD) image from outside, and the first image processor may supply the OSD image to the second image processor.

According to the configuration, even in the second back-end processor, an OSD image can be appropriately superimposed.

According to an aspect 5 of the present disclosure, there is provided a display apparatus (1) including: the image processing apparatus according to any one of the aspects 1 to 4; and a display (14).

According to an aspect 6 of the present disclosure, there is provided an image processing apparatus including: a first image processor; and a second image processor, in which a first entire input image is constituted by four first-unit input images (for example, IMGA to IMGD), in which a second entire input image is constituted by four second-unit input images (for example, INGE to IMGH), in which the image processing apparatus processes one of the first entire input image and the second entire input image, in which the first entire input image and the second entire input image are input to the first image processor and the second image processor according to any one of following (input mode 1) and (input mode 2), (input mode 1): the four first-unit input images are input to the first image processor, and the four second-unit input images are input to the second image processor; (input mode 2): three of the first-unit input images and one of the second-unit input images are input to the first image processor, and one of the first-unit input images and three of the second-unit input images, which are not input to the first image processor, are input to the second image processor; in which, in a case where the image processing apparatus processes the first entire input image, the first image processor (i) processes one or more predetermined first-unit input images among three or more first-unit input images which are input to the first image processor, and (ii) supplies remaining first-unit input images excluding the one or more predetermined first-unit input images, to the second image processor, and the second image processor processes at least one of (i) the one of the first-unit input images which is not input to the first image processor and (ii) the remaining first-unit input images supplied from the first image processor, and in which, in a case where the image processing apparatus processes the second entire input image, the second image processor (i) processes one or more predetermined second-unit input images among three or more second-unit input images which are input to the second image processor, and (ii) supplies remaining second-unit input images excluding the one or more predetermined second-unit input images, to the first image processor, and the first image processor processes at least one of (i) the one of the second-unit input images which is not input to the second image processor and (ii) the remaining second-unit input images supplied from the second image processor.

According to the configuration, a switcher can be omitted, and thus the configuration of the image processing apparatus can be simplified as compared with the configuration in the related art.

According to an aspect 7 of the present disclosure, in the image processing apparatus according to the aspect 6, the first entire input image and the second entire input image may be input to the first image processor and the second image processor according to the (input mode 1). Further, in a case where the image processing apparatus processes the first entire input image, the first image processor may (i) process two predetermined first-unit input images among the four first-unit input images which are input to the first image processor, and (ii) supply two remaining first-unit input images excluding the two predetermined first-unit input images, to the second image processor, and the second image processor may process the two remaining first-unit input images supplied from the first image processor. Further, in a case where the image processing apparatus processes the second entire input image, the second image processor may (i) process two predetermined second-unit input images among the four second-unit input images which are input to the second image processor, and (ii) supply two remaining second-unit input images excluding the two predetermined second-unit input images, to the first image processor, and the first image processor may process the two remaining second-unit input images supplied from the second image processor.

According to an aspect 8 of the present disclosure, in the image processing apparatus according to the aspect 6, the first entire input image and the second entire input image may be input to the first image processor and the second image processor according to the (input mode 2). Further, in a case where the image processing apparatus processes the first entire input image, the first image processor may (i) process two predetermined first-unit input images among the three of the first-unit input images which are input to the first image processor, and (ii) supply one remaining first-unit input image excluding the two predetermined first-unit input images, to the second image processor, and the second image processor may process both (i) the one of the first-unit input images which is not input to the first image processor and (ii) the one remaining first-unit input image supplied from the first image processor. Further, in a case where the image processing apparatus processes the second entire input image, the second image processor may (i) process two predetermined second-unit input images among the three of the second-unit input images which are input to the second image processor, and (ii) supply one remaining second-unit input image excluding the two predetermined second-unit input images, to the second image processor, and the first image processor may process both (i) the one of the second-unit input images which is not input to the second image processor and (ii) the one remaining second-unit input image supplied from the second image processor.

According to an aspect 9 of the present disclosure, in the image processing apparatus according to the aspect 6, the first entire input image and the second entire input image may be input to the first image processor and the second image processor according to the (input mode 2). Further, in a case where the image processing apparatus processes the first entire input image, the first image processor may acquire the one of the first-unit input images which is not input to the first image processor, from the second image processor, the first image processor may (i) process a predetermined first-unit input image among the three of the first-unit input images which are initially input to the first image processor, (ii) process the one of the first-unit input images acquired from the second image processor, and (iii) supply two remaining first-unit input images excluding the predetermined first-unit input image, to the second image processor, and the second image processor may process the two remaining first-unit input images supplied from the first image processor. Further, in a case where the image processing apparatus processes the second entire input image, the second image processor may acquire the one of the second-unit input images which is not input to the second image processor, from the first image processor, the second image processor may (i) process a predetermined second-unit input image among the three of the second-unit input images which are initially input to the second image processor, (ii) process the one of the second-unit input images acquired from the first image processor, and (iii) supply two remaining second-unit input images excluding the predetermined second-unit input image, to the first image processor, and the first image processor may process the two remaining second-unit input images supplied from the second image processor.

According to an aspect 10 of the present disclosure, there is provided a display apparatus including: the image processing apparatus according to any one of the aspects 6 to 9; and a display.

[Appendix]

An aspect of the present disclosure is not limited to the above-described embodiments, and various modifications may be made within a scope described in the claims. Further, an embodiment obtained by appropriately combining each technical means disclosed in different embodiments falls within a technical scope of the aspect of the present disclosure. Furthermore, by combining technical means disclosed in each embodiment, it is possible to form a new technical feature.

(Another Expression of Aspect of Present Disclosure)

An aspect of the present disclosure may also be expressed as follows.

That is, according to an aspect of the present disclosure, there is provided an image processing apparatus including a plurality of back-end processors that process input images, in which each of the back-end processors includes means for receiving a plurality of input images, and in which the plurality of back-end processors switch and process the plurality of input images.

Further, according to an aspect of the present disclosure, there is provided an image processing apparatus that processes any one of a first entire input image and a second entire input image and includes a first image processor and a second image processor, in which the first entire input image is constituted by four first partial input picture images, in which the second entire input image is constituted by four second partial input picture images, in which the first entire input image and the second entire input image are input to the first image processor and the second image processor according to one of following two ways: (1) the four first partial input, picture images are input to the first image processor, and the four second partial input picture images are input to the second image processor; and (2) the three first partial input picture images and the one second partial input picture image are input to the first image processor, and the one first partial input picture image and the three second partial input picture images are input to the second image processor, in which, in a case where the image processing apparatus processes the first entire input image, the first image processor processes the two first partial input picture images among (a plurality of) the first partial input picture images which are input to the first image processor, and outputs the remaining first partial input picture images to the second image processor, and the second image processor processes the one first partial input picture image which is initially input to the second image processor and/or the remaining first partial input picture images which are output from the first image processor, and in which, in a case where the image processing apparatus processes the second entire input image, the second image processor processes the two second partial input picture images among (a plurality of) the second partial input picture images which are input to the second image processor, and outputs the remaining second partial input picture images to the first image processor, and the first image processor processes the one second partial input picture image which is initially input to the first image processor and/or the remaining second partial input picture images which are output from the second image processor.

1. An image processing apparatus comprising:
a first image processor; and
a second image processor,
wherein a first entire input image is constituted by combining a first sub input image and a first residual input image,
wherein a second entire input image is constituted by combining a second sub input image and a second residual input image,
wherein the first sub input image and the second sub input image are input to the first image processor,
wherein the first residual input image and the second residual input image are input to the second image processor,
wherein the image processing apparatus processes one of the first entire input image and the second entire input image,
wherein, in a case where the image processing apparatus processes the first entire input image,
the first image processor processes the first sub input image, and the second image processor processes the first residual input image, and
wherein, in a case where the image processing apparatus processes the second entire input image,
the first image processor processes the second sub input image, and the second image processor processes the second residual input image.

2. The image processing apparatus according to claim 1,
wherein, in the first entire input image,
a boundary of the first sub input image that is adjacent to the first residual input image is set as a first sub input boundary image, and
a boundary of the first residual input image that is adjacent to the first sub input image is set as a first residual input boundary image,
wherein, in a case where the image processing apparatus processes the first entire input image,
the first image processor supplies the first sub input boundary image to the second image processor,
the second image processor supplies the first residual input boundary image to the first image processor,
the first image processor processes the first sub input image by referring to the first residual input boundary image supplied from the second image processor, and
the second image processor processes the first residual input image by referring to the first sub input boundary image supplied from the first image processor,
wherein, in the second entire input image,
a boundary of the second sub input image that is adjacent to the second residual input image is set as a second sub input boundary image, and
a boundary of the second residual input image that is adjacent to the second sub input image is set as a second residual input boundary image, and
wherein, in a case where the image processing apparatus processes the second entire input image,
the first image processor supplies the second sub input boundary image to the second image processor,
the second image processor supplies the second residual input boundary image to the first image processor,
the first image processor processes the second sub input image by referring to the second residual input boundary image supplied from the second image processor, and
the second image processor processes the second residual input image by referring to the second sub input boundary image supplied from the first image processor,

3. The image processing apparatus according to claim 1,
wherein, in a case where the image processing apparatus processes the first entire input image,
the first image processor supplies the first sub input image to the second image processor,
the second image processor supplies the first residual input image to the first image processor,
the first image processor processes the first sub input image by referring to the first residual input image supplied from the second image processor, and
the second image processor processes the first residual input image by referring to the first sub input image supplied from the first image processor, and
wherein, in a case where the image processing apparatus processes the second entire input image,
the first image processor supplies the second sub input image to the second image processor,
the second image processor supplies the second residual input image to the first image processor,
the first image processor processes the second sub input image by referring to the second residual input image supplied from the second image processor, and
the second image processor processes the second residual input image by referring to the second sub input image supplied from the first image processor.

4. The image processing apparatus according to claim 3,
wherein the first image processor acquires an OSD image from outside, and
wherein the first image processor supplies the OSD image to the second image processor.

5. A display apparatus comprising:
the image processing apparatus according to claim 1;
a display.

6. An image processing apparatus comprising:
a first image processor; and
a second image processor,
wherein a first entire input image is constituted by four first-unit input images,
wherein a second entire input image is constituted by four second-unit input images,
wherein the image processing apparatus processes one of the first entire input e and the second entire input image,
wherein the first entire input image and the second entire input image are input to the first image processor and the d image processor according to any one of following (input mode 1) and (input mode 2),
(input mode 1):
the four first-unit input images are input to the first image processor, and
the four second-unit input images are input to the second image processor,
(input mode 2):
three of the first-unit input images and one of the second-unit input images are input to the first image processor, and
one of the first-unit input images and three of the second-unit input images, which are not input to the first image processor, are input to the second image processor;
wherein, in a case where the image processing apparatus processes the first entire input image,
the first image processor (i) processes one or more predetermined first-unit input images among three or more first-unit input images which are input to the first image processor, and (ii) supplies remaining first-unit input images excluding the one or more predetermined first-unit input images, to the second image processor, and
the second image processor processes at least one of (i) the one of the first-unit input images which is not input to the first image processor and (ii) the remaining first-unit input images supplied from the first image processor, and
wherein, in a case where the image processing apparatus processes the second entire input image,
the second image processor (i) processes one or more predetermined second-unit input images among three or more second-unit input images which are input to the second image processor, and (ii) supplies remaining second-unit input images excluding the one or more predetermined second-unit input images, to the first image processor, and
the first image processor processes at least one of (i) the one of the second-unit input images which is not input to the second image processor and (ii) the remaining second-unit input images supplied from the second image processor.

7. The image processing apparatus according to claim 6,
wherein the first entire input image and the second entire input image are input to the first image processor and the second image processor according to the (input mode 1),
wherein, in a case where the image processing apparatus processes the first entire input image,
the first image processor (i) processes two predetermined first-unit input images among the four first-unit input images which are input to the first image processor, and (ii) supplies two remaining first-unit input images excluding the two predetermined first-unit input images, to the second image processor, and
the second image processor processes the two remaining first-unit input ages supplied from the first image processor, and
wherein, in a case where the image processing apparatus processes the second entire input image,
the second image processor (i) processes two predetermined second-unit input images among the four second-unit input images which are input to the second image processor, and (ii) supplies two remaining second-unit input images excluding the two predetermined second-unit input images, to the first image processor, and
the first image processor processes the two remaining second-unit input images supplied from the second image processor.

8. The image processing apparatus according to claim 6,
wherein the first entire input image and the second entire input image arc input to the first image processor and the second image processor according to the (input mode 2),
wherein, in a case where the image processing apparatus processes the first entire input image,
the first image processor (i) processes two predetermined first-unit input images among the three of the first-unit input images which arc input to the first image processor, and (ii) supplies one remaining first-unit input image excluding the two predetermined first-unit input images, to the second image processor, and
the second image processor processes both (i) the one of the first-unit input images which is not input to the first image processor and (ii) the one remaining first-unit input image supplied from the first image processor, and
wherein, in a case where the image processing apparatus processes the second entire input image,
the second image processor (i) processes two predetermined second-unit input images among the three of the second-unit input images which are input to the second image processor, and (ii) supplies one remaining second-unit input image excluding the two predetermined second-unit input images, to the first image processor, and
the first image processor processes both (i) the one of the second-unit input images which is not input to the second image processor and (ii) the one remaining second-unit input image supplied from the second image processor.

9. The image processing apparatus according to claim 6,
wherein the first entire input image and the second entire input image arc input to the first image processor and the second image processor according to the (input mode 2),
wherein, in a case where the image processing apparatus processes the first entire input image,
the first image processor acquires the one of the first-unit input images which is not input to the first image processor, from the second image processor,
the first image processor (i) processes a predetermined first-unit input image among the three of the first-unit input images which are initially input to the first image processor, (ii) processes the one of the first-unit input images acquired from the second image processor, and (iii) supplies two remaining first-unit input images excluding the predetermined first-unit input image, to the second image processor, and
the second image processor processes the two remaining first-unit input images supplied from the first image processor, and
wherein, in a case where the image processing apparatus processes the second entire input image,
the second image processor acquires the one of the second-unit input images which is not input to the second image processor, from the first image processor,
the second image processor (i) processes a predetermined second-unit input image among the three of the second-unit input images which arc initially input to the second image processor, (ii) processes the one of the second-unit input images acquired from the first image processor, and (iii) supplies two remaining second-unit input images excluding the predetermined second-unit input image, to the first image processor, and
the first image processor processes the two remaining second-unit input images supplied from the second image processor.

10. (canceled)
